(19) United States
(12) Patent Application Publication
(10) Pub. No.: US 2025/0294353 A1
(43) Pub. Date: Sep. 18, 2025

(54) First Node, Second Node, Third Node, Communications System and Methods Performed Thereby for Handling Security

(71) Applicant: Telefonaktiebolaget LM Ericsson (publ), Stockholm (SE)

(72) Inventors: Miguel Angel Muñoz De La Torre Alonso, Madrid (ES); Ridrigo Alvarez Dominguez, Madrid (ES); Jose Corbacho Gil, Segovia (ES)

(21) Appl. No.: 18/290,923

(22) PCT Filed: Nov. 10, 2021
(86) PCT No.: PCT/EP2021/081267

§ 371 Date: Jan. 22, 2024

(30) Foreign Application Priority Data
Sep. 24, 2021 (EP) 21382858.5

(51) Int. Cl. H04W 12/08

(52) U.S. Cl. CPC H04W 12/08

(57) ABSTRACT

A computer-implemented method. performed by a first node (111). The method is for handling security. The first node (111) operates in a communications system (100). The first node (111) determines (403). out of one or more second nodes (112) operating in the communications system (100), which one or more selected second nodes fulfil one or more security criteria to handle data. The determining (403) is based on a respective first indication indicating one or more respective characteristics of a respective security infrastructure of the one or more selected second nodes. The first node (111) sends (405) a request to establish a connection to one of the selected second nodes.

### CROSS-REFERENCE TO RELATED APPLICATION

This application is a Submission Under 35 U.S.C. § 371 for U.S. National Stage Patent Application of International Application Number: PCT/EP2021/081267, filed Sep. 24, 2021 entitled “FIRST NODE, SECOND NODE, THIRD NODE, COMMUNICATIONS SYSTEM AND METHODS PERFORMED THEREBY FOR HANDLING SECURITY,” the entirety of which is incorporated herein by reference.

### TECHNICAL FIELD

The present disclosure relates generally to a first node and methods performed thereby for handling security. The present disclosure also relates generally to a second node, and methods performed thereby, for handling security. The present disclosure also relates generally to a third node, and methods performed thereby for handling security. The present disclosure further relates generally to a communications system and methods performed thereby for handling security.

### BACKGROUND

Computer systems in a communications network may comprise one or more network nodes. A node may comprise one or more processors which, together with computer program code may perform different functions and actions, a memory, a receiving port and a sending port. A node may be, for example, a server. Nodes may perform their functions entirely on the cloud.

The communications network may cover a geographical area which may be divided into cell areas, each cell area being served by another type of node, a network node in the Radio Access Network (RAN), radio network node or Transmission Point (TP), for example, an access node such as a Base Station (BS), e.g. a Radio Base Station (RBS), which sometimes may be referred to as e.g., evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The telecommunications network may also be a non-cellular system, comprising network nodes which may serve receiving nodes, such as user equipments, with serving beams.

The standardization organization Third Generation Partnership Project (3GPP) is currently in the process of specifying a New Radio Interface called Next Generation Radio or New Radio (NR) or 5G-UTRA, as well as a Fifth Generation (5G) Packet Core Network, which may be referred to as 5G Core Network (5GC), abbreviated as 5GC.

A 3GPP system comprising a 5G Access Network (AN), a 5GC and a UE may be referred to as a 5G system.

FIG. 1 is a schematic diagram depicting a particular example of a 5G reference architecture as defined by 3GPP, which may be used as a reference for the present disclosure. A Network Repository Function (NRF) 1 may support a service discovery function. The NRF 1 may receive a Network Function (NF) Discovery Request from a NF instance, and may provide the information of the discovered NF instances. The NRF 1 may also maintain the NF profile of available NF instances and their supported services. The Policy Control Function (PCF) 2 may support a unified policy framework to govern the network behavior. Specifically, the PCF 2 may provide Policy and Charging Control (PCC) rules to the Session Management Function (SMF) 3. The SMF 3 may support different functionalities, e.g., may configure the User Plane Function (UPF) 4 accordingly, e.g. for event reporting. The UPF 4 may support handling of user plane traffic based on the rules received from the SMF 3, e.g. packet inspection and different enforcement actions such as event detection and reporting. Also depicted in FIG. 1 is a Network Data Analytics Function (NWDAF) 5, a Network Exposure Function (NEF) 6, a Unified Data Management (UDM) 7, an Application Function (AF) 8, an Authentication Server Function (AUSF) 9, an Access and Mobility Management (IEFunction (AMF) 10, a User Equipment (UE) 11, a Radio Access Network (RAN) 12, and a Data Network (DN) 13. Each of the NSSF 5, the NEF 6, the NRF 1, the PCF 2, the UDM 7, the AF 8, the AUSF 9, the AMF 10, the SMF 3, the UE 11, the RAN 12, the UPF 4 and the DN 13 may have an interface through which they may be accessed, which as depicted in the Figure, may be, respectively: Nnssf 14, Nnef 15, Nnrf 16, Npcf 17, Nudm 18, Naf 19, Nausf 20, Namf 21, Nsmf 22, N1 23, N2 24 and N4 25. The RAN 12 may have an interface N3 26 with the UPF 4. The UPF 4 may have an interface N6 27 with the DN 13.

FIG. 2 is a schematic diagram depicting a particular example of a Network Functions Virtualization (NFV) MANagement and Orchestration (MANO) architectural framework in 5G with reference points, which may be used as a reference for the present disclosure. A complete description of the architecture may be found in the ETSI MANO architecture description in ETSI GS NFV-MAN 001 v. 1.1.1, FIG. 4.1-1. In FIG. 2, short lines crossing bold lines indicate Main NFV reference points, whereas short lines crossing dashed lines indicate other reference points. Lines between solid circles indicate execution reference points.

### UPF Selection

In 3GPP TS 23.501, sections 6.3.3.3 and 6.3.3.2, it is said that UPF selection for a particular session may be based on the following information. The following parameter(s) and information may be considered by the SMF for UPF selection and re-selection: a) UPF's dynamic load, b) UPF's relative static capacity among UPFs supporting the same Data Network Name (DNN), c) UPF location available at the SMF, d) UE location information, e) capability of the UPF and the functionality required for the particular UE session; an appropriate UPF may be selected by matching the functionality and features required for an UE, f) DNN, g) Protocol Data Unit (PDU) Session Type, e.g., IPv4, IPv6, IPv4v6, Ethernet Type or Unstructured Type, and if applicable, the static Internet Protocol (IP) address/prefix, h) Session and Service Continuity (SSC) mode selected for the PDU Session, i) UE subscription profile in UDM, j) Data Network Access Identifier (DNAI) as included in the Policy and Charging Control (PCC) Rules, k) Local operator policies, I) Single Network Slice Selection Assistance Information (S-NSSAI), m) access technology being used by the UE, n) information related to user plane topology and user plane terminations, that may be deduced from: i) Access Network (AN)-provided identities, e.g., CellID, Tracking Area Identity (TAI), available UPF(s) and Data Network Access Identifier (DNAI(s)), ii) information regarding the user plane interfaces of UPF(s); this information may be acquired by the SMF using N4, iii) information regarding the N3 User Plane termination(s) of the AN serving the UE-this may be deduced from AN-provided identities, e.g., CellID, TAI, iv) information regarding the N9 User Plane termination(s) of UPF(s) if needed, and v) information regarding the User plane termination(s) corresponding to DNAI(s). How the SMF may determine information about the user plane network topology from information listed above, and what information may be considered by the SMF, may be based on operator configuration.

### NF profile

In 3GPP TS 29.510, v. 16.5.0, section 6.1.6.2.2, it is defined the NF profile that may comprise several attributes such as IP address and/or Frequently Qualified Domain Name (FQDN) of the NF, name of the NF and specific information depending on each NF. For example, upfinfo may be defined in 3GPP TS 29.510, v. 16.5.0, section 6.1.6.2.13.

### Security Concepts

Trusted Execution Environment (TEE) may be understood as an environment where code may execute and data may be used in isolation. Isolation may be understood to mean that code and data cannot be tampered or observed from outside the TEE.

Attestation may be understood as a mechanism for software to prove its identity. The goal of attestation may be understood to be to prove to a remote party that an operating system and application software may be understood to be intact and trustworthy. The verifier may trust that attestation data is accurate.

The term Trusted Computing may apply to a number of distinct proposals and initiatives with the general goal of engineering more security into commodity computing systems. Some generally agreed upon features of trusted computing may be understood to be: a) secure boot, which may be understood to allow the system to boot into a defined and trusted configuration, b) curtained memory, which may be understood to provide strong memory isolation; that is, memory that cannot be read by other processes including operating systems and debuggers; c) sealed storage, which may be understood to allow software to keep cryptographically secure secrets; d) secure input/output (I/O) thwarts attacks such as key-stroke loggers and screen scrapers, e) integrity measurement, which may be understood as the ability to compute hashes of executable code, configuration data, and other system state information, and f) remote attestation, which may be understood to allow a trusted device to present reliable evidence to remote parties about the software it may be running.

In spite of the foregoing security mechanisms that may be available for network communications, users of network services may still be vulnerable to security attacks.

### SUMMARY

As part of the development of embodiments herein, one or more challenges with the existing technology will first be identified and discussed.

Under current, newer cloud models, different parties may share network infrastructure. Such as setup makes the parties vulnerable to attack of their respective software by malicious parties in the shared infrastructure.

According to the foregoing, it is an object of embodiments herein to improve the handling of security in a communications system.

According to a first aspect of embodiments herein, the object is achieved by a computer-implemented method, performed by a first node. The method is for handling security. The first node operates in a communications system. The first node determines, out of one or more second nodes operating in the communications system, which one or more selected second nodes fulfil one or more security criteria to handle data. The determining is based on a respective first indication indicating one or more respective characteristics of a respective security infrastructure of the one or more selected second nodes. The first node then sends a request to establish a connection to one of the selected second nodes.

According to a second aspect of embodiments herein, the object is achieved by a computer-implemented method, performed by a second node. The method is for handling security. The second node operates in the communications system. The second node sends a respective first message indicating the respective first indication to a third node operating in the communications system. The respective first indication indicates the one or more respective characteristics of the respective security infrastructure of the second node.

According to a third aspect of embodiments herein, the object is achieved by a computer-implemented method, performed by the third node. The method is for handling security. The third node operates in the communications system. The third node receives a previous indication from the first node operating in the communications system. The previous indication requests to indicate the one or more respective characteristics of the respective security infrastructure of respective one or more second nodes operating in the communications system. The third node also sends the respective first indication to the first node, based on the received previous indication. The respective first indication indicates the one or more respective characteristics of the respective security infrastructure of the one or more second nodes.

According to a fourth aspect of embodiments herein, the object is achieved by a computer-implemented method, performed by the communications system. The method is for handling security. The communications system comprises the first node, the one or more second nodes and the third node. The method comprises sending, by the one or more second nodes, the respective first message indicating the respective first indication to the third node. The respective first indication indicates the one or more respective characteristics of the respective security infrastructure of the one or more second nodes. The method also comprises receiving, by the third node, the respective first messages indicating the respective first indication from the respective one or more second nodes. The respective first indication indicates the one or more respective characteristics of the respective security infrastructure of the respective one or more second nodes. The method then comprises sending, by the first node, the previous indication to the third node. The previous indication requests to indicate the one or more respective characteristics of the respective security infrastructure of the respective one or more second nodes. The method also comprises receiving, by the third node, the previous indication from the first node. The method also comprises sending, by the third node, based on the received previous indication, the respective first indication indicating the one or more respective characteristics of the respective security infrastructure of the one or more second nodes. The method additionally comprises obtaining, by the first node, the respective first indication from the third node based on the sent previous indication. The method further comprises determining, by the first node, out of the one or more second nodes, which one or more selected second nodes fulfil the one or more security criteria to handle data. The determining is based on the respective first indication. The method then comprises sending, by the first node, the request to establish the connection to the one of the selected second nodes.

According to a fifth aspect of embodiments herein, the object is achieved by the first node, for handling security. The first node is configured to operate in the communications system. The first node is further configured to determine, out of the one or more second nodes configured to operate in the communications system, which one or more selected second nodes are configured to fulfil the one or more security criteria to handle data. The determining is configured to be based on the respective first indication configured to indicate the one or more respective characteristics of the respective security infrastructure of the one or more selected second nodes. The first node is further configured to send the request to establish the connection to one of the selected second nodes.

According to a sixth aspect of embodiments herein, the object is achieved by the second node, for handling security. The second node is configured to operate in the communications system. The second node is further configured to send the respective first message configured to indicate the respective first indication to the third node configured to operate in the communications system. The respective first indication is configured to indicate the one or more respective characteristics of the respective security infrastructure of the second node.

According to a seventh aspect of embodiments herein, the object is achieved by the third node, for handling security. The third node is configured to operate in the communications system. The third node is configured to receive the previous indication from the first node configured to operate in the communications system. The previous indication is configured to request to indicate the one or more respective characteristics of the respective security infrastructure of the respective one or more second nodes configured to operate in the communications system. The third node is further configured to send the respective first indication to the first node, based on the previous indication configured to be received. The respective first indication is configured to indicate the one or more respective characteristics of the respective security infrastructure of the one or more second nodes.

According to an eighth aspect of embodiments herein, the object is achieved by the communications system, for handling security. The communications system comprises the first node, the one or more second nodes and the third node. The communications system is further configured to send, by the one or more second nodes, the respective first message configured to indicate the respective first indication to the third node. The respective first indication is configured to indicate the one or more respective characteristics of the respective security infrastructure of the one or more second nodes. The communications system is also configured to receive, by the third node, the respective first messages configured to indicate the respective first indication from the respective one or more second nodes. The respective first indication is configured to indicate the one or more respective characteristics of the respective security infrastructure of the respective one or more second nodes. The communications system is further configured to send, by the first node, the previous indication to the third node. The previous indication is configured to request to indicate the one or more respective characteristics of the respective security infrastructure of the respective one or more second nodes. The communications system is additionally configured to receive, by the third node, the previous indication from the first node. The communications system is also configured to send, by the third node, based on the previous indication configured to be received, the respective first indication configured to indicate the one or more respective characteristics of the respective security infrastructure of the one or more second nodes. The communications system is also configured to obtain, by the first node, the respective first indication from the third node based on the previous indication configured to be sent. The communications system is further configured to determine, by the first node, out of the one or more second nodes, which one or more selected second nodes are configured to fulfil one or more security criteria to handle data. The determining is configured to be based on the respective first indication. The communications system is further configured to send, by the first node, the request to establish the connection to one of the selected second nodes.

By the one or more second nodes sending the respective first message indicating the respective first indication to the third node, and the third node receiving it, the third node is enabled to be aware of the one or more respective characteristics of the respective security infrastructure of the one or more second nodes. The third node is thereby enabled to provide this information to the first node, so that the first node may be enabled to determine which of the one or more second nodes fulfil the one or more security criteria to handle data. Optionally, the third node may be enabled to determine itself which of the one or more second nodes fulfil the one or more security criteria to handle data.

By the first node sending the previous indication to the third node and the third node receiving it, the third node may be enabled to know which one or more respective characteristics of the respective security infrastructure the one or more second nodes may need to be indicated back to the first node, or which respective security infrastructure the one or more second nodes may need to have to be selected by the third node and then indicated to the first node as second nodes fulfilling the one or more security criteria.

By the third node sending the respective first indication to the first node, the first node is enabled to then determine which one or more selected second nodes fulfil the one or more security criteria to handle data. The first node is thereby enabled to know to which selected one or more second nodes to send the request to establish the connection. The first node thereby enables to guarantee that the data for a particular device may be handled with the one or more security criteria the data may require.

As a consequence, the communications system may be enabled to handle data for the device with the security criteria that the data may require, thereby preventing that security attacks may be performed on sensitive data.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a 5G Network Architecture, non-roaming.

FIG. 2 is a schematic diagram illustrating a non-limiting example of an NFV-MANO architectural framework with reference points.

FIG. 3 is a schematic diagram illustrating a non-limiting example of a communications system, according to embodiments herein.

FIG. 4 is a flowchart depicting embodiments of a method in a first node, according to embodiments herein.

FIG. 5 is a flowchart depicting embodiments of a method in a second node, according to embodiments herein.

FIG. 6 is a flowchart depicting embodiments of a method in a third node, according to embodiments herein.

FIG. 7 is a flowchart depicting embodiments of a method in a communications system, according to embodiments herein.

FIG. 8 is a schematic diagram depicting a non-limiting example of signalling between nodes in a communications system, according to embodiments herein.

FIG. 9 is a schematic diagram depicting a non-limiting example of signalling between nodes in a communications system, according to embodiments herein.

FIG. 10 is a schematic diagram depicting a non-limiting example of signalling between nodes in a communications system, according to embodiments herein.

FIG. 11 is a schematic block diagram illustrating two non-limiting examples, a) and b), of a first node, according to embodiments herein.

FIG. 12 is a schematic block diagram illustrating two non-limiting examples, a) and b), of a second node, according to embodiments herein.

FIG. 13 is a schematic block diagram illustrating two non-limiting examples, a) and b), of a third node, according to embodiments herein.

FIG. 14 is a schematic block diagram illustrating two non-limiting examples, a) and b), of a communications system, according to embodiments herein.

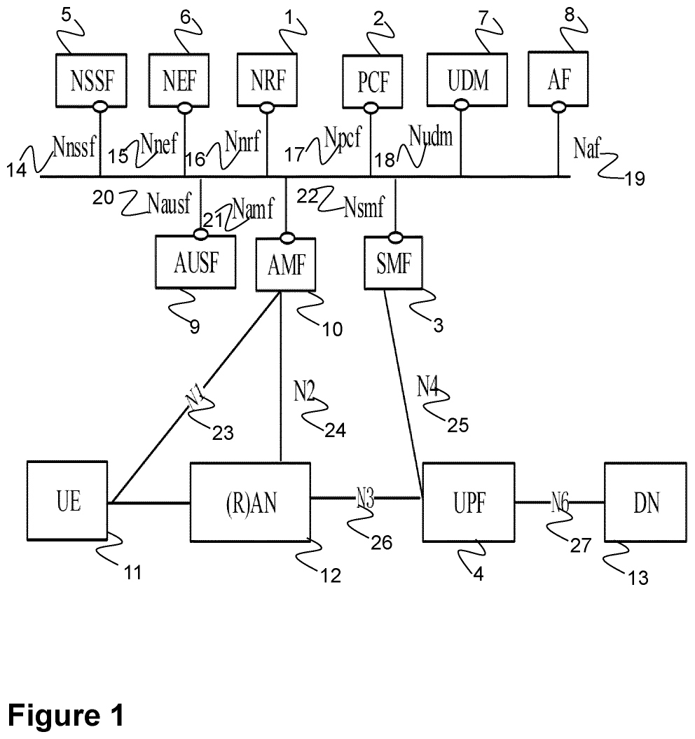

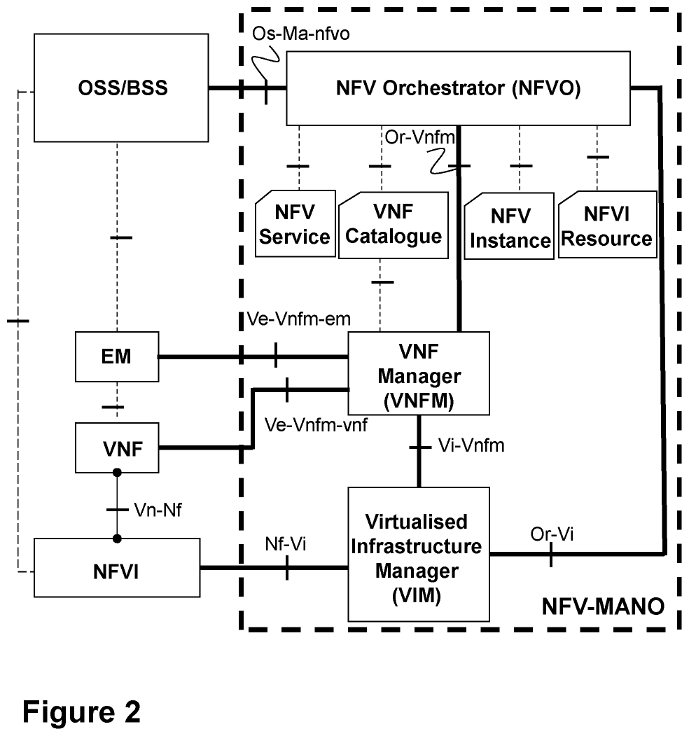

### DETAILED DESCRIPTION

Certain aspects of the present disclosure and their embodiments address one or more of the challenges identified with the existing methods and provide solutions to the challenges discussed.

Embodiments herein may be understood to relate to method for NF selection based on attestation. As a summarized overview, embodiments herein may be understood to be based on extending the NF registration and discovery procedures to allow NF selection based on security infrastructure characteristics. Embodiments herein may provide a mechanism for registering NF capabilities related to security parameters infrastructure where an NF may be running its software. According to this information, the corresponding nodes at the PDU session establishment may be enabled to select which specific NF instance they may want to use based on this information.

3GPP TS 29.510, v. 16.5.0 defines procedures for registering and update an NF in the NRF. According to embodiments herein, new parameters are proposed in the following existing procedures. In the NF registration to NRF, embodiments herein may comprise registering security infrastructure characteristics such as, for example, if the platform has secure boot, remote software attestation. In the NF update to NRF, embodiments herein may comprise updating information on security infrastructure characteristics such as, for example, if the platform has secure boot, remote software attestation. At PDU session establishment, defined in 3GPP TS 23.501, embodiments herein may comprise the (re) selection of the NF based on security infrastructure characteristics. For example, when a certain subscriber may require a feature such as content filtering, the SMF may select a UPF instance supporting security infrastructure characteristics.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

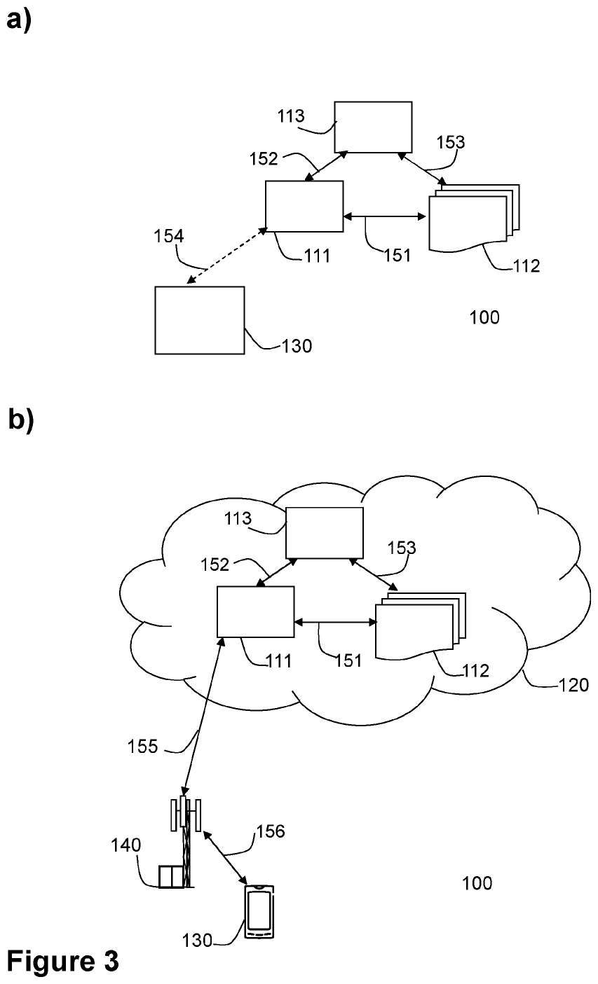

FIG. 3 depicts two non-limiting examples, in panels “a” and “b”, respectively, of a communications system 100, in which embodiments herein may be implemented. In some example implementations, such as that depicted in the non-limiting example of FIG. 3a, the communications system 100 may be a computer network. In other example implementations, such as that depicted in the non-limiting example of FIG. 3b, the communications system 100 may be implemented in a telecommunications system, sometimes also referred to as a telecommunications network, cellular radio system, cellular network or wireless communications system. In some examples, the telecommunications system may comprise network nodes which may serve receiving nodes, such as wireless devices, with serving beams.

In some examples, the telecommunications system may for example be a network such as 5G system, or a newer system supporting similar functionality. The telecommunications system may also support other technologies, such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 may comprise a plurality of nodes, and/or operate in communication with other nodes, whereof a first node 111, one or more second nodes 112 and a third node 113, are depicted in FIG. 3. The one or more second nodes 112 comprise a second node 112. Any of the first node 111, the one or more second nodes 112 and the third node 113 may be understood, respectively, as a first computer system, a second computer system and a third computer system. In some examples, any of the first node 111, the one or more second nodes 112 and the third node 113 may be implemented as a standalone server in e.g., a host computer in the cloud 120, as depicted in the non-limiting example depicted in panel b) of FIG. 3. Any of the first node 111, the one or more second nodes 112 and the third node 113 may in some examples be a distributed node or distributed server, with some of their respective functions being implemented locally, e.g., by a client manager, and some of its functions implemented in the cloud 120, by e.g., a server manager. Yet in other examples, any of the first node 111, the one or more second nodes 112 and the third node 113 may also be implemented as processing resources in a server farm.

Any of the first node 111, the one or more second nodes 112 and the third node 113 may be independent and separate nodes.

It may be understood that the communications system 100 may comprise more nodes than those represented on FIG. 3.

In some examples of embodiments herein, the first node 111 may be understood as a node that may need to select another node to handle data, according to embodiments herein. Non-limiting examples of the first node 111 may be an AMF or an SMF in 5G, e.g., in a 5G network.

The one or more second nodes 112 may be the nodes being selected by the first node 111 to handle data. In particular examples, the one or more second nodes 112 may be an AMF, an SMF or a PCF in 5G, e.g., in a 5G network.

The third node 113 may be a node having a capability to provide information on other nodes and receive inquiries for such information. In some particular examples, the third node 113 may be an NRF, e.g., in a 5G network.

In some embodiments wherein the communications system 100 may be a 5G network, at least one of the following may apply: the first node 111 may be a first network function, the one or more second nodes 112 may be second network functions, and the third node 113 may be a network repository function.

The communications system 100 may comprise a plurality of devices whereof a device 130 is depicted in FIG. 3. The device 130 may be also known as e.g., user equipment (UE), a wireless device, mobile terminal, wireless terminal and/or mobile station, mobile telephone, cellular telephone, or laptop with wireless capability, or a Customer Premises Equipment (CPE), just to mention some further examples. The device 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet computer, sometimes referred to as a tablet with wireless capability, or simply tablet, a Machine-to-Machine (M2M) device, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. The device 130 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100.

The communications system 100 may comprise one or more radio network nodes, whereof a radio network node 140 is depicted in FIG. 3b. The radio network node 140 may typically be a base station or Transmission Point (TP), or any other network unit capable to serve a wireless device or a machine type node in the communications system 100. The radio network node 140 may be e.g., a 5G gNB, a 4G eNB, or a radio network node in an alternative 5G radio access technology, e.g., fixed or WiFi. The radio network node 140 may be e.g., a Wide Area Base Station, Medium Range Base Station, Local Area Base Station and Home Base Station, based on transmission power and thereby also coverage size. The radio network node 140 may be a stationary relay node or a mobile relay node. The radio network node 140 may support one or several communication technologies, and its name may depend on the technology and terminology used. The radio network node 140 may be directly connected to one or more networks and/or one or more core networks.

The communications system 100 covers a geographical area which may be divided into cell areas, wherein each cell area may be served by a radio network node, although, one radio network node may serve one or several cells.

The first node 111 may communicate with the one or more second nodes 112 over a respective first link 151, e.g., a radio link or a wired link. The first node 111 may communicate with the third node 113 over a second link 152, e.g., a radio link or a wired link. The third node 113 may communicate, directly or indirectly, with the one or more second nodes 112 over a respective third link 153, e.g., a radio link or a wired link. The first node 111 may communicate, directly or indirectly, with the device 130 over a fourth link 154, e.g., a radio link or a wired link. The first node 111 may communicate, directly or indirectly with the radio network node 140 over a fifth link 155, e.g., a radio link or a wired link. The radio network node 140 may communicate with the device 130 over a sixth link 156, e.g., a radio link. Any of the respective first link 151, the second link 152, the respective third link 153, the fourth link 154, the fifth link 155 and/or the sixth link 156 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 3.

In general, the usage of “first”, “second”, “third”, “fourth”, “fifth” and/or “sixth” herein may be understood to be an arbitrary way to denote different elements or entities, and may be understood to not confer a cumulative or chronological character to the nouns these adjectives modify.

Although terminology from Long Term Evolution (LTE)/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies. For example, although the examples of embodiments herein may be described in the context of a 5G network architecture, the same mechanisms may be applied to a 4G network, just by replacing NRF by Domain Name Server (DNS), UDR by Subscriber Profile Repository (SPR), AMF by Mobility Management Entity (MME), SMF by Packet Data Network Gateway Control-Plane (PGW-C), and UPF by Packet Data Network Gateway User Plane (PGW-U).

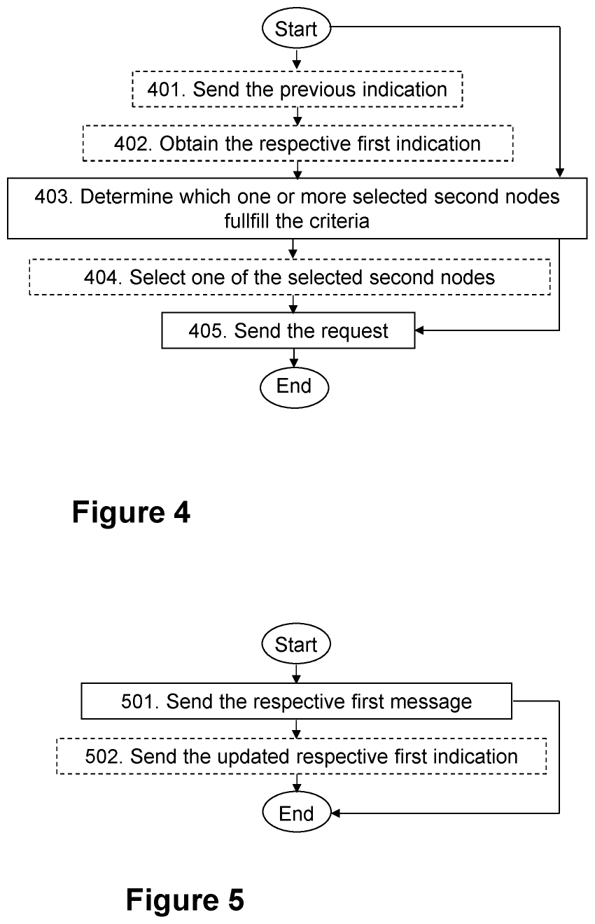

Embodiments of a computer-implemented method, performed by the first node 111, will now be described with reference to the flowchart depicted in FIG. 4. The method may be understood to be for handling security. The first node 111 operates in the communications system 100.

The method comprises the actions described below. One or more embodiments may be combined, where applicable. All possible combinations are not described to simplify the description. It should be noted that the examples herein are not mutually exclusive. Components from one example or embodiment may be tacitly assumed to be present in another example or embodiment and it will be obvious to a person skilled in the art how those components may be used in the other examples or embodiments.

### Action 401

During the course of operations in the communications system 100, the communications system 100 may need to handle data for the device 130. For that purpose, one of the nodes in the communications system 100, e.g., the first node 111 in some examples, may receive a PDU Session Establishment Request from the device 130. The node in the communications system 100 that may receive such request, or that may subsequently handle data for such request, may then request subscriber information corresponding to the device 130. For example, the first node 111 may be an AMF which may, after receiving the PDU Session Establishment Request from the device 130, send a Nudr_Get_Request (SUPI) to a Unified Data Repository (UDR), and the UDR may return the requested subscriber information in a Nudr_Get_Response (200). As another non-limiting example, the first node 111 may be an SMF sending a Nudr Get Session Management Subscription Data (Subscriber) to a UDR, and the UDR may send an Nudr Session Management Subscription Data (200) back. The subscriber information may indicate that data, e.g., any data, to be handled for the device 130 is to fulfil one or more security criteria, further described below. This may be due to the fact that the device 130 may belong to a high ranking official, such as a president of a country, or an enterprise that may need to have secure secrets and it may require content filtering.

According to the foregoing, in this Action 401, the first node 111 may send an indication, referred to herein as a previous indication, to the third node 113 operating in the communications system 100. The previous indication may request to indicate one or more respective characteristics of a respective security infrastructure of the respective one or more second nodes 112.

The one or more second nodes 112 may be indicated as a type of the one or more second nodes 112, e.g., an NF type, such as e.g., PCF, SMF, UPF, etc.

The sending of the first request may be performed e.g., via the second link 152.

The security infrastructure may comprise hardware and/or software components that may allow that an infrastructure may comply with security requirements. The security requirements may be, for example, those referred to as the confidentiality, integrity, availability (CIA) triad. Confidentiality may be understood to refer to an organization's efforts to keep their data private or secret. It may ensure that only those who may be authorized, may have access to specific assets, and that those who may be unauthorized may be actively prevented from obtaining access. Integrity may be understood to refer to the quality of something being whole or complete. Integrity may ensure that data has not been tampered with and, therefore, may be trusted. That is, that the data is correct, authentic, and reliable. Availability may be understood to ensure that authorized users may have timely, reliable access to resources when they may be needed.

The one or more respective characteristics may indicate whether or not a respective second node may be capable of at least one of the following options. According to a first option a), booting into a defined and trusted configuration, that is, capable of performing a secure boot. This may be indicated by Secure boot Boolean information, which may define if the system may boot into a defined and trusted configuration.

According to a second option b), storing cryptographically secure information, that is, capable of sealed storage. This may be indicated by Sealed Storage Boolean information, which may define if software may keep cryptographically secure secrets.

According to a third option c), providing memory isolation, that is, capable of curtained memory. This may be indicated by Curtained memory Boolean information, which may define if the system may provide strong memory isolation memory that may not be read by other processes including operating systems and debuggers.

According to a fourth option d), providing secure input and output, that is, capable of secure I/O. This may be indicated by Secure I/O Boolean information that may define if the system may provide a mechanism for protecting from attacks such as key-stroke loggers and screen scrapers.

According to a fifth option e), computing hashes of information, that is, capable of integrity measurement. This may be indicated by Integrity measurement Boolean information that may define if the system may compute hashes of executable code, configuration data, and other system state information.

According to a sixth option f), enabling remote attestation, that is, capable of remote attestation. This may be indicated by Remote attestation Boolean information that may define if a system may present reliable evidence to remote parties about the software it may be running.

Each of the one or more respective characteristics may be attributes indicated in an information element (IE) comprised in a respective profile corresponding to the one or more second nodes 112. The IE may be, e.g., a security IE. The IE may be considered as a new IE in the NF profile defined in the 3GPP TS 29.510, v. 16.5.0, as depicted in Table 6.1.6.2.2-1, which is depicted in Table 1, with the new IE disclosed herein.

TABLE 1

| Attribute name | Data type | P | Cardinality | Description |
|---|---|---|---|---|
| nfInstanceId | NfInstanceId | M | 1 | Unique identity of the NF Instance. |
| nfType | NFType | M | 1 | Type of Network Function |
| nfStatus | NFStatus | M | 1 | Status of the NF Instance (NOTE 5) |
| nfInstanceName | string | O | 0 . . . 1 | Human readable name of the NF Instance |
| heartBeatTimer | integer | C | 0 . . . 1 | Time in seconds expected between 2 consecutive |
| | | | | heart-beat messages from an NF Instance to the |
| | | | | NRF. |
| | | | | It may be included in the registration request. When |
| | | | | present in the request it shall contain the heartbeat |
| | | | | time proposed by the NF service consumer. |
| | | | | It shall be included in responses from NRF to |
| | | | | registration requests (PUT) or in NF profile updates |
| | | | | (PUT or PATCH). If the proposed heartbeat time is |
| | | | | acceptable by the NRF based on the local |
| | | | | configuration, it shall use the same value as in the |
| | | | | registration request; otherwise the NRF shall |
| | | | | override the value using a preconfigured value. |
| plmnList | array(PlmnId) | C | 1 . . . N | PLMN(s) of the Network Function (NOTE 7). |
| | | | | This IE shall be present if this information is |
| | | | | available for the NF. |
| | | | | If not provided, PLMN ID(s) of the PLMN of the NRF |
| | | | | are assumed for the NF. |
| snpnList | array(PlmnIdNid) | C | 1 . . . N | SNPN(s) of the Network Function. |
| | | | | This IE shall be present if the NF pertains to one or |
| | | | | more SNPNs. |
| sNssais | array(ExtSnssai) | O | 1 . . . N | S-NSSAIs of the Network Function. |
| | | | | If not provided, and if the perPImnSnssaiList attribute |
| | | | | is not present, the NF can serve any S-NSSAI. |
| | | | | When present this IE represents the list of S-NSSAIs |
| | | | | supported in all the PLMNs listed in the plmnList IE. |
| | | | | If the sNSSAIs attribute is provided in at least one |
| | | | | NF Service, the S-NSSAIs supported by the NF |
| | | | | Profile shall be the set or a superset of the S- |
| | | | | NSSAIs of the NFService(s). |
| perPlmnSnssaiList | array(PlmnSnssai) | O | 1 . . . N | This IE may be included when the list of S-NSSAIs |
| | | | | supported by the NF for each PLMN it is supporting |
| | | | | is different. When present, this IE shall include the S- |
| | | | | NSSAIs supported by the Network Function for each |
| | | | | PLMN supported by the Network Function. When |
| | | | | present, this IE shall override sNssais IE. (NOTE 9) |
| | | | | If the perPImnSnssaiList attribute is provided in at |
| | | | | least one NF Service, the S-NSSAIs supported per |
| | | | | PLMN in the NF Profile shall be the set or a superset |
| | | | | of the perPImnSnssaiList of the NFService(s). |
| nsiList | array(string) | O | 1 . . . N | NSI identities of the Network Function. |
| | | | | If not provided, the NF can serve any NSI. |
| Fqdn | Fqdn | C | 0 . . . 1 | FQDN of the Network Function (NOTE 1) (NOTE 2). |
| | | | | For AMF, the FQDN registered with the NRF shall be |
| | | | | that of the AMF Name (see 3GPP 23.003 [12] clause |
| | | | | 28.3.2.5). |
| interPlmnFqdn | Fqdn | C | 0 . . . 1 | If the NF needs to be discoverable by other NFs in a |
| | | | | different PLMN, then an FQDN that is used for inter- |
| | | | | PLMN routing as specified in 3GPP 23.003 [12] shall |
| | | | | be registered with the NRF (NOTE 8). |
| | | | | A change of this attribute shall result in triggering a |
| | | | | “NF_PROFILE_CHANGED” notification from NRF |
| | | | | towards subscribing NFs located in a different |
| | | | | PLMN, but the new value shall be notified as a |
| | | | | change of the “fqdn” attribute. |
| Ipv4Addresses | array(Ipv4Addr) | C | 1 . . . N | Ipv4 address(es) of the Network Function (NOTE 1) |
| | | | | (NOTE 2) |
| ipv6Addresses | array(Ipv6Addr) | C | 1 . . . N | Ipv6 address(es) of the Network Function (NOTE 1) |
| | | | | (NOTE 2) |
| allowedPlmns | array(PlmnId) | O | 1 . . . N | PLMNs allowed to access the NF instance. |
| | | | | If not provided, any PLMN is allowed to access the |
| | | | | NF. |
| | | | | A change of this attribute shall not trigger a |
| | | | | “NF_PROFILE_CHANGED” notification from NRF, |
| | | | | and this attribute shall not be included in profile |
| | | | | change notifications to subscribed NFs. |
| allowedSnpns | array(PlmnIdNid) | O | 1 . . . N | SNPNs allowed to access the NF instance. |
| | | | | If this attribute is present in the NFService and in the |
| | | | | NF profile, the attribute from the NFService shall |
| | | | | prevail. |
| | | | | The absence of this attribute in both the NFService |
| | | | | and in the NF profile indicates that no SNPN, other |
| | | | | than the SNPN(s) registered in the snpnList attribute |
| | | | | of the NF Profile, is allowed to access the service |
| | | | | instance. |
| | | | | A change of this attribute shall not trigger a |
| | | | | “NF_PROFILE_CHANGED” notification from NRF, |
| | | | | and this attribute shall not be included in profile |
| | | | | change notifications to subscribed NFs. |
| allowedNfTypes | array(NFType) | O | 1 . . . N | Type of the NFs allowed to access the NF instance. |
| | | | | If not provided, any NF type is allowed to access the |
| | | | | NF. |
| | | | | A change of this attribute shall not trigger a |
| | | | | “NF_PROFILE_CHANGED” notification from NRF, |
| | | | | and this attribute shall not be included in profile |
| | | | | change notifications to subscribed NFs. |
| allowedNfDomains | array(string) | 0 | 1 . . . N | Pattern (regular expression according to the ECMA- |
| | | | | 262 dialect [8]) representing the NF domain names |
| | | | | within the PLMN of the NRF allowed to access the |
| | | | | NF instance. |
| | | | | If not provided, any NF domain is allowed to access |
| | | | | the NF. |
| | | | | A change of this attribute shall not trigger a |
| | | | | “NF_PROFILE_CHANGED” notification from NRF, |
| | | | | and this attribute shall not be included in profile |
| | | | | change notifications to subscribed NFs. |
| allowedNssais | array(ExtSnssai) | O | 1 . . . N | S-NSSAI of the allowed slices to access the NF |
| | | | | instance. |
| | | | | If not provided, any slice is allowed to access the |
| | | | | NF. |
| | | | | A change of this attribute shall not trigger a |
| | | | | “NF_PROFILE_CHANGED” notification from NRF, |
| | | | | and this attribute shall not be included in profile |
| | | | | change notifications to subscribed NFs. |
| Priority | integer | O | 0 . . . 1 | Priority (relative to other NFs of the same type) |
| | | | | within the range 0 to 65535, to be used for NF |
| | | | | selection; lower values indicate a higher priority. |
| | | | | Priority may or may not be present in the |
| | | | | nfServiceList parameters, xxxInfo parameters and in |
| | | | | this attribute. Priority in the nfServiceList has |
| | | | | precedence over the priority in this attribute, which |
| | | | | has precedence over the priority in xxxInfo |
| | | | | parameter. (NOTE 4). |
| | | | | The NRF may overwrite the received priority value |
| | | | | when exposing an NFProfile with the |
| | | | | Nnrf_NFDiscovery service. |
| Capacity | integer | O | 0 . . . 1 | Static capacity information within the range 0 to |
| | | | | 65535, expressed as a weight relative to other NF |
| | | | | instances of the same type; if capacity is also |
| | | | | present in the nfServiceList parameters, those will |
| | | | | have precedence over this value. (NOTE 4). |
| Load | integer | O | 0 . . . 1 | Dynamic load information, within the range 0 to 100, |
| | | | | indicates the current load percentage of the NF. |
| loadTimeStamp | DateTime | O | 0 . . . 1 | It indicates the point in time in which the latest load |
| | | | | information (sent by the NF in the “load” attribute of |
| | | | | the NF Profile) was generated at the NF Instance. |
| | | | | If the NF did not provide a timestamp, the NRF |
| | | | | should set it to the instant when the NRF received |
| | | | | the message where the NF provided the latest load |
| | | | | information. |
| Locality | string | O | 0 . . . 1 | Operator defined information about the location of |
| | | | | the NF instance (e.g. geographic location, data |
| | | | | center) (NOTE 3) |
| udrInfo | UdrInfo | O | 0 . . . 1 | Specific data for the UDR (ranges of SUPI, group ID |
| | | | | . . . ) |
| udrInfoList | map(UdrInfo) | O | 1 . . . N | Multiple entries of UdrInfo. This attribute provides |
| | | | | additional information to the udrInfo. udrInfoList may |
| | | | | be present even if the udrInfo is absent. |
| | | | | The key of the map shall be a (unique) valid JSON |
| | | | | string per clause 7 of IETF RFC 8259 [22], with a |
| | | | | maximum of 32 characters. |
| udmInfo | UdmInfo | O | 0 . . . 1 | Specific data for the UDM (ranges of SUPI, group |
| | | | | ID . . . ) |
| udmInfoList | map(UdmInfo) | O | 1 . . . N | Multiple entries of UdmInfo. This attribute provides |
| | | | | additional information to the udmInfo. udmInfoList |
| | | | | may be present even if the udmInfo is absent. |
| | | | | The key of the map shall be a (unique) valid JSON |
| | | | | string per clause 7 of IETF RFC 8259 [22], with a |
| | | | | maximum of 32 characters. |
| ausfInfo | AusfInfo | O | 0 . . . 1 | Specific data for the AUSF (ranges of SUPI, group |
| | | | | ID . . . ) |
| ausfInfoList | map(AusfInfo) | O | 1 . . . N | Multiple entries of AusfInfo. This attribute provides |
| | | | | additional information to the ausfInfo. ausfInfoList |
| | | | | may be present even if the ausfInfo is absent. |
| | | | | The key of the map shall be a (unique) valid JSON |
| | | | | string per clause 7 of IETF RFC 8259 [22], with a |
| | | | | maximum of 32 characters. |
| amfInfo | AmfInfo | O | 0 . . . 1 | Specific data for the AMF (AMF Set ID, . . . ) |
| amfInfoList | map(AmfInfo) | O | 1 . . . N | Multiple entries of AmfInfo. This attribute provides |
| | | | | additional information to the amfInfo. amfInfoList |
| | | | | may be present even if the amfInfo is absent. |
| | | | | The key of the map shall be a (unique) valid JSON |
| | | | | string per clause 7 of IETF RFC 8259 [22], with a |
| | | | | maximum of 32 characters. |
| smfInfo | SmfInfo | O | 0 . . . 1 | Specific data for the SMF (DNN's, . . . ). |
| | | | | (NOTE 12) |
| smfInfoList | map(SmfInfo) | O | 1 . . . N | Multiple entries of SmfInfo. This attribute provides |
| | | | | additional information to the smfInfo. smfInfoList may |
| | | | | be present even if the smfInfo is absent. |
| | | | | The key of the map shall be a (unique) valid JSON |
| | | | | string per clause 7 of IETF RFC 8259 [22], with a |
| | | | | maximum of 32 characters. |
| | | | | (NOTE 12) |
| upfInfo | UpfInfo | O | 0 . . . 1 | Specific data for the UPF (S-NSSAI, DNN, SMF |
| | | | | serving area, interface . . . ) |
| upfInfoList | map(UpfInfo) | O | 1 . . . N | Multiple entries of UpfInfo. This attribute provides |
| | | | | additional information to the upfInfo. upfInfoList may |
| | | | | be present even if the upfInfo is absent. |
| | | | | The key of the map shall be a (unique) valid JSON |
| | | | | string per clause 7 of IETF RFC 8259 [22], with a |
| | | | | maximum of 32 characters. |
| pcfInfo | PcfInfo | O | 0 . . . 1 | Specific data for the PCF |
| pcfInfoList | map(PcfInfo) | O | 1 . . . N | Multiple entries of PcfInfo. This attribute provides |
| | | | | additional information to the pcfInfo. pcfInfoList may |
| | | | | be present even if the pcfInfo is absent. |
| | | | | The key of the map shall be a (unique) valid JSON |
| | | | | string per clause 7 of IETF RFC 8259 [22], with a |
| | | | | maximum of 32 characters. |
| bsfInfo | BsfInfo | O | 0 . . . 1 | Specific data for the BSF |
| bsfInfoList | map(BsfInfo) | O | 1 . . . N | Multiple entries of BsfInfo. This attribute provides |
| | | | | additional information to the bsfInfo. bsfInfoList may |
| | | | | be present even if the bsfInfo is absent. |
| | | | | The key of the map shall be a (unique) valid JSON |
| | | | | string per clause 7 of IETF RFC 8259 [22], with a |
| | | | | maximum of 32 characters. |
| chfInfo | ChfInfo | O | 0 . . . 1 | Specific data for the CHF |
| chfInfoList | map(ChfInfo) | O | 1 . . . N | Multiple entries of ChfInfo. This attribute provides |
| | | | | additional information to the chfInfo. chfInfoList may |
| | | | | be present even if the chfInfo is absent. |
| | | | | The key of the map shall be a (unique) valid JSON |
| | | | | string per clause 7 of IETF RFC 8259 [22], with a |
| | | | | maximum of 32 characters. |
| nefInfo | NefInfo | O | 0 . . . 1 | Specific data for the NEF |
| nrfInfo | NrfInfo | O | 0 . . . 1 | Specific data for the NRF |
| udsfInfo | UdsfInfo | O | 0 . . . 1 | Specific data for the UDSF |
| udsfInfoList | map(UdsfInfo) | O | 1 . . . N | Multiple entries of udsfInfo. This attribute provides |
| | | | | additional information to the udsfInfo. udsfInfoExt |
| | | | | may be present even if the udsfInfo is absent. |
| nwdafInfo | NwdafInfo | O | 0 . . . 1 | Specific data for the NWDAF. |
| pcscfInfoList | map(PcscfInfo) | O | 1 . . . N | Specific data for the P-CSCF. |
| | | | | The key of the map shall be a (unique) valid JSON |
| | | | | string per clause 7 of IETF RFC 8259 [22], with a |
| | | | | maximum of 32 characters. |
| | | | | (NOTE 11) |
| hssInfoList | map(HssInfo) | O | 1 . . . N | Specific data for the HSS. |
| | | | | The key of the map shall be a (unique) valid JSON |
| | | | | string per clause 7 of IETF RFC 8259 [22], with a |
| | | | | maximum of 32 characters. |
| customInfo | object | O | 0 . . . 1 | Specific data for custom Network Functions |
| recovery Time | DateTime | O | 0 . . . 1 | Timestamp when the NF was (re)started (NOTE 5) |
| | | | | (NOTE 6) |
| nfServicePersistence | boolean | O | 0 . . . 1 | true: If present, and set to true, it indicates that the |
| | | | | different service instances of a same NF Service in |
| | | | | this NF instance, supporting a same API version, are |
| | | | | capable to persist their resource state in shared |
| | | | | storage and therefore these resources are available |
| | | | | after a new NF service instance supporting the same |
| | | | | API version is selected by a NF Service Consumer |
| | | | | (see 3GPP 23.527 [27]). |
| | | | | false (default): Otherwise, it indicates that the NF |
| | | | | Service Instances of a same NF Service are not |
| | | | | capable to share resource state inside the NF |
| | | | | Instance. |
| nfServices | array(NFService) | O | 1 . . . N | List of NF Service Instances. It shall include the |
| | | | | services produced by the NF that can be discovered |
| | | | | by other NFs, if any. (NOTE 15) |
| | | | | This attribute is deprecated; the attribute |
| | | | | “nfServiceList” should be used instead. |
| nfServiceList | map(NFService) | O | 1 . . . N | Map of NF Service Instances, where the |
| | | | | “serviceInstanceld” attribute of the NFService object |
| | | | | shall be used as the key of the map. (NOTE 15) |
| | | | | It shall include the services produced by the NF that |
| | | | | can be discovered by other NFs, if any. |
| nfProfileChangesSuppo | boolean | O | 0 . . . 1 | NF Profile Changes Support Indicator. |
| rtInd | | | | See Annex B. |
| | | | | This IE may be present in the NFRegister or |
| | | | | NFUpdate (NF Profile Complete Replacement) |
| | | | | request and shall be absent in the response. |
| | | | | True: the NF Service Consumer supports receiving |
| | | | | NF Profile Changes in the response. |
| | | | | False (default): the NF Service Consumer does not |
| | | | | support receiving NF Profile Changes in the |
| | | | | response. |
| | | | | Write-Only: true |
| nfProfileChangesInd | boolean | O | 0 . . . 1 | NF Profile Changes Indicator. |
| | | | | See Annex B. |
| | | | | This IE shall be absent in the request to the NRF |
| | | | | and may be included by the NRF in NFRegister or |
| | | | | NFUpdate (NF Profile Complete Replacement) |
| | | | | response. |
| | | | | True: the NF Profile contains NF Profile changes. |
| | | | | False (default): complete NF Profile. |
| | | | | Read-Only: true |
| defaultNotificationSubsc | array(DefaultNotif | O | 1 . . . N | Notification endpoints for different notification types. |
| riptions | icationSubscription) | | | (NOTE 10) |
| ImfInfo | LmfInfo | O | 0 . . . 1 | Specific data for the LMF |
| gmlcInfo | GmlcInfo | O | 0 . . . 1 | Specific data for the GMLC |
| nfSetIdList | array(NfSetId) | C | 1 . . . N | NF Set ID defined in clause 28.12 of |
| | | | | 3GPP TS 23.003 [12]. |
| | | | | At most one NF Set ID shall be indicated per PLMN |
| | | | | of the NF. |
| | | | | This information shall be present if available. |
| servingScope | array(string) | O | 1 . . . N | The served area(s) of the NF instance. |
| | | | | The absence of this attribute does not imply that the |
| | | | | NF instance can serve every area in the PLMN. |
| | | | | (NOTE 13) |
| IcHSupportInd | boolean | O | 0 . . . 1 | This IE indicates whether the NF supports Load |
| | | | | Control based on LCI Header (see clause 6.3 of |
| | | | | 3GPP TS 29.500 [4]). |
| | | | | true: the NF supports the feature. |
| | | | | false (default): the NF does not support |
| | | | | the feature. |
| olcHSupportInd | boolean | 0 | 10 . . . 1 | This IE indicates whether the NF supports Overload |
| | | | | Control based on OCI Header (see clause 6.4 of |
| | | | | 3GPP TS 29.500 [4]). |
| | | | | true: the NF supports the feature. |
| | | | | false (default): the NF does not support |
| | | | | the feature. |
| nfSetRecoveryTimeList | map(DateTime) | O | 1 . . . N | Map of recovery time, where the key of the map is |
| | | | | the NfSetld of NF Set(s) that the NF instance |
| | | | | belongs to. |
| | | | | When present, the value of each entry of the map |
| | | | | shall be the recovery time of the NF Set indicated by |
| | | | | the key. |
| serviceSetRecovery | map(DateTime) | O | 1 . . . N | Map of recovery time, where the key of the map is |
| TimeList | | | | the NfServiceSetld of the NF Service Set(s) |
| | | | | configured in the NF instance. |
| | | | | When present, the value of each entry of the map |
| | | | | shall be the recovery time of the NF Service Set |
| | | | | indicated by the key. |
| scpDomains | array(string) | O | 1 . . . N | When present, this IE shall carry the list of SCP |
| | | | | domains the SCP belongs to, or the SCP domain the |
| | | | | NF (other than SCP) belongs to. |
| | | | | (NOTE 14) |
| scpInfo | ScpInfo | O | 0 . . . 1 | Specific data for the SCP |
| security | Security Info | O | 0 . . . 1 | Specific info relative to security |

NOTE 1:
At least one of the addressing parameters (fqdn, ipv4address or ipv6adress) shall be included in the NF Profile. If the NF supports the NF services with “https” URI scheme (i.e use of TLS is mandatory), then the FQDN shall be provided in the NF Profile or the NF Service profile (see clause 6.1.6.2.3). See NOTE 1 of Table 6.1.6.2.3-1 for the use of these parameters. If multiple ipv4 addresses and/or ipv6 addresses are included in the NF Profile, the NF Service Consumer of the discovery service shall select one of these addresses randomly, unless operator defined local policy of IP address selection, in order to avoid overload for a specific ipv4 address and/or ipv6 address.
NOTE 2:
If the type of Network Function is UPF, the addressing information is for the UPF N4 interface.
NOTE 3:
A requester NF may use this information to select a NF instance (e.g. a NF instance preferably located in the same data center).
NOTE 4:
The capacity and priority parameters, if present, are used for NF selection and load balancing. The priority and capacity attributes shall be used for NF selection in the same way that priority and weight are used for server selection as defined in IETF RFC 2782 [23].
NOTE 5:
The NRF shall notify NFs subscribed to receiving notifications of changes of the NF profile, if the NF recoveryTime or the nfStatus is changed. See clause 6.2 of 3GPP 23.527 [27].
NOTE 6:
A requester NF may consider that all the resources created in the NF before the NF recovery time have been lost. This may be used to detect a restart of a NF and to trigger appropriate actions, e.g. release local resources. See clause 6.2 of 3GPP 23.527 [27].
NOTE 7:
A NF may register multiple PLMN IDs in its profile within a PLMN comprising multiple PLMN IDs. If so, all the attributes of the NF Profile shall apply to each PLMN ID registered in the plmnList. As an exception, attributes including a PLMN ID, e.g. IMSI-based SUPI ranges, TAls and GUAMIs, are specific to one PLMN ID and the NF may register in its profile multiple occurrences of such attributes for different PLMN IDs (e.g. the UDM may register in its profile SUPI ranges for different PLMN IDs).
NOTE 8:
Other NFs are in a different PLMN if they belong to none of the PLMN ID(s) configured for the PLMN of the NRF.
NOTE 9:
This is for the use case where an NF (e.g. AMF) supports multiple PLMNs and the slices supported in each PLMN are different. See clause 9.2.6.2 of 3GPP TS 38.413 [29].
NOTE 10:
If notification endpoints are present both in the profile of the NF instance (NFProfile) and in some of its NF Services (NFService) for a same notification type, the notification endpoint(s) of the NF Services shall be used for this notification type.
NOTE 11:
The absence of the pcscfInfoList attribute in a P-CSCF profile indicates that the P-CSCF can be selected for any DNN and Access Type.
NOTE 12:
The absence of both the smfInfo and smfInfoList attributes in an SMF profile indicates that the SMF can be selected for any S-NSSAI, DNN, TAI and access type.
NOTE 13:
The servingScope attribute may indicate geographical areas, It may be used e.g. to discover and select NFs in centralized Data Centers that are expected to serve users located in specific region(s) or province(s). It may also be used to reduce the large configuration of TAls in the NF instances.
NOTE 14:
An NF (other than a SCP) can register at most one SCP domain in NF profile, i.e. the NF can belong to only one SCP domain. If an NF (other than a SCP) includes this information in its profile, this indicates that the services produced by this NF should be accessed preferably via an SCP from the SCP domain the NF belongs to.
NOTE 15:
If the NF Service Consumer that issues an NF profile retrieval request indicates support for the “Service-Map” feature, the NRF shall return in the NF profile retrieval response the list of NF Service Instances in the “nfServiceList” map attribute. Otherwise, the NRF shall return the list of NF Service Instances in the “nfServices” array attribute.

In the IE, Security Info may indicate the one or more respective characteristics by indicating one or more of the following parameters, as described earlier: Secure boot Boolean information, Sealed Storage Boolean information, Curtained memory Boolean information, Secure I/O Boolean information, Integrity measurement Boolean information, and Remote attestation Boolean information.

In some examples, the previous indication may request to indicate which of the one or more second nodes 112 may fulfil the one or more security criteria. As one non-limiting example, the one or more security criteria may be that the one or more second nodes 112 may need to be included in a trusted environment. Any, or each, of the one or more security criteria may, for example, specify a particular value the one or more respective characteristics may be required to have, e.g., a “yes” type of value or a certain capacity for storing cryptographically secure information.

As a non-limiting example, for examples wherein the third node 113 may be an NRF, the previous indication may be an Nnrf_NFDiscovery_Request requesting a profile of a particular type of second node, e.g., an SMF profile, which may list the request one or more characteristics, e.g., Security {Sealed Storage, Curtained memory, integrity measurement}.

By sending the previous indication request in this Action 401, the first node 111 may be enabled to inquire about the security characteristics of the one or more second nodes 112, and eventually use this information to choose the second node 112 according to its security characteristics, according to the data it may need to handle for a particular device 130.

### Action 402

In this Action 402, the first node 111 may obtain a respective first indication from the third node 113 based on the sent previous indication. That is, the first node 111 may obtain the respective indication in response to the sent previous indication. The respective first indication may indicate the one or more respective characteristics of the respective security infrastructure of the respective one or more second nodes 112.

The obtaining, e.g., receiving, of the first indication may be performed e.g., via the second link 152.

In some embodiments, the respective first indication may be comprised in a message. The message may further comprise a list. In some examples, the list may comprise the one or more second nodes 112.

As a non-limiting example, for examples wherein the third node 113 may be an NRF, the respective first indication may be a respective profile of the particular type of second node, e.g., an SMF profile. The respective profile may list the requested one or more characteristics, and respective identifiers of the one or more second nodes 112. The message may be an Nnrf_NFDiscovery_Response comprising the list of respective profiles of the particular type of second node, e.g., an SMF profile. The message may further comprise a respective identifier for each of the one or more second nodes 112, e.g., an SMF ID, if the type of the one or more second nodes 112 is an SMF.

By obtaining the respective first indication in this Action 402, the first node 111 may be enabled to then determine which of the one or more second nodes 112 may fulfil one or more security criteria to handle data.

### Action 403

In this Action 403, the first node 111 determines, out of the one or more second nodes 112 operating in the communications network 100, which one or more selected second nodes fulfil the one or more security criteria to handle data. The determining in this Action 403 may be based on the respective first indication indicating the one or more respective characteristics of the respective security infrastructure of the one or more selected second nodes.

Determining may be understood as calculating, deriving or selecting.

In some embodiments wherein the respective first indication received in Action 402 may be comprised in the message, one of the following may apply. The message may further comprise the list. In a first group of embodiments, the list may comprise the one or more selected second nodes fulfilling the one or more criteria, as selected by the third node 113. In such first group of embodiments, the determining in this Action 403 may comprise decoding, or extracting the one or more selected nodes from the respective first indication. That is, in Action 403, the first node 111 may have obtained with the respective first indication from the third node 113, an answer to the previous indication comprising a list of instances of the one or more second nodes 112 matching the requested profile, e.g., NF Profile, with a new parameter, e.g., the IE Security, with the corresponding one or more characteristics as attributes. In other words, the selection of the selected one or more second nodes 112 fulfilling the one or more security criteria may be performed by the third node 113, or by the first node 111.

In a second group of embodiments, the list may indicate the one or more second nodes 112 and the determining in this Action 403 may comprise selecting the one or more selected second nodes from the list, based on the obtained respective first indication.

By determining which one or more selected second nodes fulfil the one or more security criteria to handle data in this Action 403, the first node 111 may then be enabled to send a request to establish a connection to the selected nodes, and thereby guarantee that the data for a particular device 130 may be handled with the one or more security criteria the data may require.

### Action 404

In this Action 404, the first node 111 may select a subset of the selected second nodes, or out of the one or more second nodes 112. The selecting in this Action 404 may be based on one or more additional criteria, e.g., non-security related criteria. The request to establish the connection may then be sent to at least one of one of the selected second nodes comprised in the subset.

Action 404 may be performed, in some examples, before Action 403.

By selecting the subset of the selected second nodes in this Action 404, the first node 111 may be enabled to tailor even more closely any further requirements handling the data may require, by any second nodes fulfilling the one or more security criteria.

### Action 405

In this Action 405, the first node 111 sends a request to establish a connection to one of the selected second nodes. In other words, the first node 111 may send, in this Action 405, a PDU session create to the instance of the second node that may have been selected based on the security characteristics.

The sending of the first request may be performed e.g., via the respective first link 151.

As a non-limiting example, for examples wherein the type of the one or more second nodes 112 may be an SMF, the request to establish the connection may be an Nsmf_PDUSession_Create.

By sending the request in this Action 405, the first node 111 may then be enabled to establish a connection to the one or more selected second nodes, and thereby guarantee that the data for the particular device 130 may be handled with the one or more security criteria, and or any additional criteria, the data may require.

Embodiments of a computer-implemented method performed by the second node 112, will now be described with reference to the flowchart depicted in FIG. 5. The method may be understood to be for handling security. The second node 112 operates in the communications system 100.

The method described for the second node 112 may be understood to apply to any of the one or more second nodes 112.

The method may comprise the following actions. Several embodiments are comprised herein. In some embodiments, the method may comprise all actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 5, optional actions are depicted with dashed lines.

The detailed description of some of the following corresponds to the same references provided above, in relation to the actions described for the first node 111 and will thus not be repeated here to simplify the description. For example, the IE may be considered as a new IE in the NF profile defined in the 3GPP TS 29.510, v. 16.5.0, as depicted in Table 6.1.6.2.2-1, which is depicted in Table 1, with the new IE disclosed herein.

### Action 501

In this Action 501, the second node 112 sends a respective first message indicating the respective first indication to the third node 113 operating in the communications system 100. The respective first indication indicates the one or more respective characteristics of the respective security infrastructure of the second node 112.

The receiving of the previous request may be performed e.g., via the respective third link 153.

In some examples wherein the communications system 100 may be a 5G network, at least one of the following may apply: a) the second node 112 may be an NF, and b) the third node 113 may be an NRF.

For examples wherein the third node 113 may be the NRF, the respective first message may be, for example, an Nnrf_NFMgmt NFRegister message to an NRF. The respective first message may further include the respective identifier of the second node 112, e.g., SMF_ID, and the respective profile of the second node 112, e.g., NF profile.

The one or more respective characteristics may indicate whether or not the second node 112 may be capable of at least one of: a) booting into the defined and trusted configuration, b) storing cryptographically secure information, c) providing memory isolation, d) providing secure input and output, e) computing hashes of information, and f) enabling remote attestation.

Each of the one or more respective characteristics may be attributes indicated in the IE, e.g., the security IE, comprised in the respective profile corresponding to the second node 112.

The second node 112 may receive an acknowledgement of receipt of the respective first message, e.g., as an Nnrf_NFMgmt NFRegister {200 OK}.

By sending the respective first message in this Action 501, the second node 112 may register its respective profile with the IE described herein, indicating the one or more respective characteristics of the respective security infrastructure of the second node 112. This may then enable the third node 113 to indicate the one or more respective characteristics of the respective security infrastructure of the second node 112 to the first node 111, and/or to perform the selection itself, and then indicate it to the first node 111, so the first node 111 may in turn be enabled to determine which second node to use in order to handle the data for the device 130, according to the one or more security criteria.

### Action 502

The second node 112 may, in some occasions, undergo changes in its respective security infrastructure, that is, update the one or more respective characteristics of its respective profile. In such occasions, the second node 112 may, in this Action 502, send an updated respective first message indicating an updated respective first indication to the third node 113. The updated respective first message may indicate updated one or more respective characteristics of the respective infrastructure of the second node 112.

The sending of the updated respective first message may be performed e.g., via the respective third link 153.

For examples wherein the third node 113 may be the NRF, the updated respective first message may be, for example, an Nnrf_NFMgmt NFUpdate message to the NRF. The updated respective first message may further include the respective identifier of the second node 112 and the updated respective profile of the second node 112.

The second node 112 may receive an acknowledgement of receipt of the updated respective first message, e.g., as another Nnrf_NFMgmt NFRegister {200 OK}.

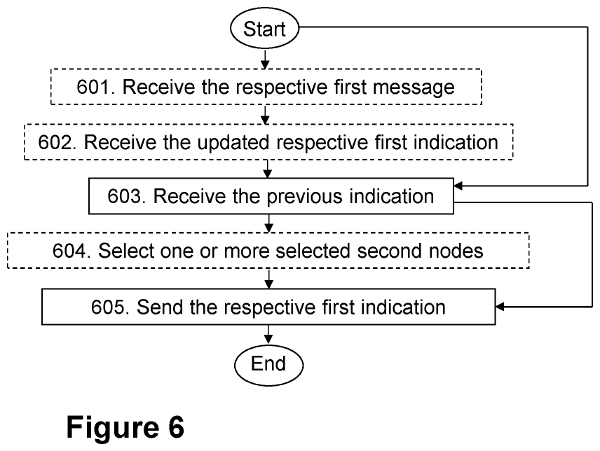

Embodiments of a computer-implemented method performed by the third node 113, will now be described with reference to the flowchart depicted in FIG. 6. The method may be understood to be for handling security. The third node 113 operates in the communications system 100.

The method may comprise the following actions. Several embodiments are comprised herein. In some embodiments, the method may comprise all actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 6, optional actions are depicted with dashed lines.

The detailed description of some of the following corresponds to the same references provided above, in relation to the actions described for the first node 111 and will thus not be repeated here to simplify the description. For example, the IE may be considered as a new IE in the NF profile defined in the 3GPP TS 29.510, v. 16.5.0, as depicted in Table 6.1.6.2.2-1, which is depicted in Table 1, with the new IE disclosed herein.

### Action 601

In this Action 601, the third node 113 may receive the respective first message indicating the respective first indication from the respective one or more second nodes 112. The respective first indication indicates the one or more respective characteristics of the respective security infrastructure of the respective one or more second nodes 112.

The receiving of the respective first message may be performed e.g., via the respective third links 153.

The one or more respective characteristics may indicate whether or not the respective second node may be capable of at least one of: a) booting into the defined and trusted configuration, b) storing cryptographically secure information, c) providing memory isolation, d) providing secure input and output, e) computing hashes of information, and f) enabling remote attestation.

Each of the one or more respective characteristics may be attributes indicated in the IE, e.g., the security IE, comprised in the respective profile, e.g., the respective NF profile, corresponding to the one or more second nodes 112.

### Action 602

In this Action 602, the third node 113 may receive the updated respective first message indicating the updated respective first indication from at least one of the respective one or more second nodes 112.

The receiving of the updated respective first message may be performed e.g., via the respective third links 153.

### Action 603

In this Action 603, the third node 113 receives the previous indication from the first node 111 operating in the communications system 100. The previous indication requests to indicate the one or more respective characteristics of the respective security infrastructure of the respective one or more second nodes 112 operating in the communications network.

The receiving of the previous indication may be performed e.g., via the second link 152.

In some examples wherein the communications system 100 may be a 5G network, at least one of the following may apply: a) the first node 111 may be a first network function, b) the one or more second nodes 112 may be second network functions, and c) the third node 113 may be an NRF.

### Action 604

In some embodiments wherein the respective first indication may be comprised in a message, the third node 113 may, in this Action 604, select the one or more selected second nodes fulfilling the one or more security criteria indicated in the previous indication.

The third node 113 may then provide the one or more selected second nodes to the first node 111 in the next Action 605.

### Action 605

In this Action 605, the third node 113 sends the respective first indication to the first node 111, based on the received previous indication. The respective first indication indicates the one or more respective characteristics of the respective security infrastructure of the one or more second nodes 112.

The sending of the respective first indication may be performed e.g., via the second link 152.

In some embodiments, the respective first indication may be comprised in the message. The message may further comprise the list comprising the one or more second nodes 112.

In the embodiments wherein Action 604 may have been performed, the one or more selected second nodes may be comprised in the list comprised in the message.

In some embodiments, the sent respective first indication may be based on the received updated respective first indication in Action 602.

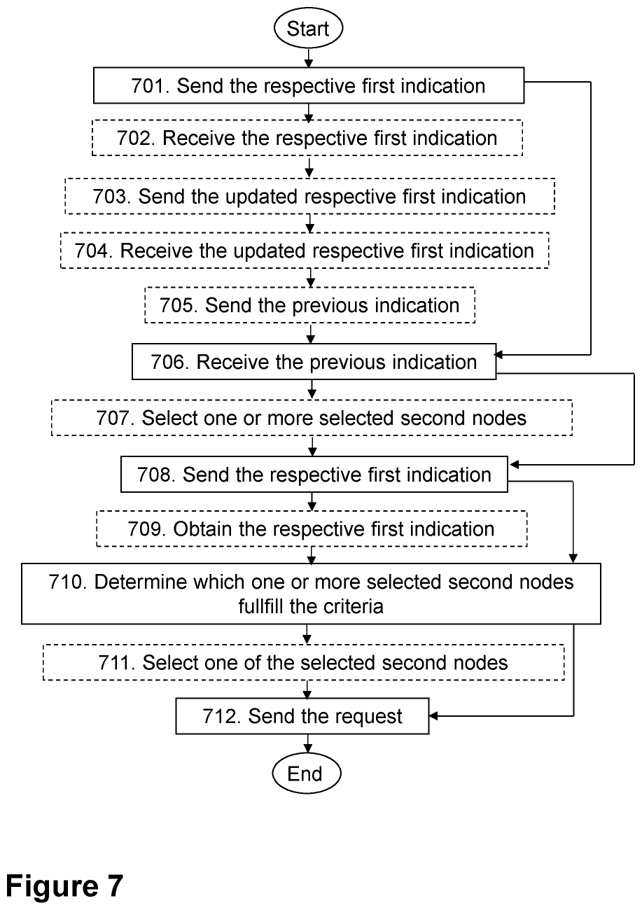

Embodiments of a computer-implemented method, performed by the communications system 100, will now be described with reference to the flowchart depicted in FIG. 7. The method may be understood to be for handling security. The communications system 100 comprises the first node 111, the one or more second nodes 112, and the third node 113.

The method may comprise the actions described below. In some embodiments some of the actions may be performed. In some embodiments all the actions may be performed. In FIG. 7, optional actions are indicated with a dashed box. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

The detailed description of some of the following corresponds to the same references provided above, in relation to the actions described for the first node 111 and will thus not be repeated here to simplify the description. For example, the communications system 100 may be a 5G network, and at least one of the following may apply: a) the first node 111 may be a first network function, b) the one or more second nodes 112 may be second network functions, and c) the third node 113 may be an NRF.

### Action 701

This Action 701, which corresponds to Action 501, comprises sending, by the one or more second nodes 112, the respective first message indicating the respective first indication to the third node 113. The respective first indication indicates the one or more respective characteristics of the respective security infrastructure of the one or more second nodes 112.

It may be understood that the sending in this Action 701 may be, respectively, by each of the one or more second nodes 112, of their respective first message.

The one or more respective characteristics may indicate whether or not the respective second node may be capable of at least one of: a) booting into the defined and trusted configuration, b) storing cryptographically secure information, c) providing memory isolation, d) providing secure input and output, e) computing hashes of information, and f) enabling remote attestation.

Each of the one or more respective characteristics may be attributes indicated in the IE, e.g., the security IE, comprised in the respective profile, e.g., the respective NF profile, corresponding to the one or more second nodes 112.

### Action 702

In some embodiments, the method may comprise, in this Action 702, which corresponds to Action 601, comprises, receiving, by the third node 113, the respective first messages. The respective first messages indicate the respective first indication from the respective one or more second nodes 112. The respective first indication indicates the one or more respective characteristics of the respective security infrastructure of the respective one or more second nodes 112.

### Action 703

In this Action 703, which corresponds to Action 502, the method comprises, sending, by at least one second node 112, the updated respective first message indicating the updated respective first indication to the third node 113.

### Action 704

In some embodiments, the method may comprise, in this Action 704, which corresponds to Action 602, receiving, by the third node 113, the updated respective first message indicating the updated respective first indication from the at least one second node 112 of the respective one or more second nodes 112.

### Action 705

In some embodiments, the method comprises, in this Action 705, which corresponds to Action 401, sending, by the first node 111, the previous indication to the third node 113. The previous indication requests to indicate the one or more respective characteristics of the respective security infrastructure of the respective one or more second nodes 112.

### Action 706

This Action 706, which corresponds to Action 603, comprises receiving, by the third node 113, the previous indication from the first node 111.

### Action 707

In some embodiments, the method may comprise, in this Action 707, which corresponds to Action 604, selecting, by the third node 113, the one or more selected second nodes fulfilling one or more security criteria indicated in the previous indication.

### Action 708

This Action 708, which corresponds to Action 605, comprises sending, by the third node 113, based on the received previous indication, the respective first indication indicating the one or more respective characteristics of the respective security infrastructure of the one or more second nodes 112.

In some embodiments wherein Action 704 may have been performed, the sent respective first indication may be based on the received updated respective first indication.

In embodiments wherein the respective first indication may be comprised in a message and wherein Action 707 may have been performed, the one or more selected second nodes may be comprised in the list comprised in the message.

### Action 709

This Action 709, which corresponds to Action 402, comprises, obtaining, by the first node 111, the respective first indication from the third node 113 based on the sent previous indication.

### Action 710

This Action 710, which corresponds to Action 403, comprises determining, by the first node 111, out of the one or more second nodes 112, which one or more selected second nodes fulfil the one or more security criteria to handle data. The determining in this Action 710 is based on the respective first indication.

As explained earlier, the determining in this Action 710 may comprise one of: selecting by the first node 111 the selected second nodes fulfilling the one or more security criteria or decoding, or extracting the one or more selected nodes from the respective first indication. In the second option, it may have been the third node 113 which may have selected the one or more selected second nodes as those fulfilling the one or more security criteria to handle data, which it may have then provided to the first node 111.

### Action 711

This Action 711, which corresponds to Action 404, may comprise, selecting the subset of the selected second nodes, or out of the one or more second nodes 112, based on the one or more additional criteria.

### Action 712

This Action 712, which corresponds to Action 405, comprises, sending, by the first node 111, the request to establish the connection to the one of the selected second nodes.

In embodiments wherein Action 711 may have been performed, the request to establish the connection may be sent to at least one of one of the selected second nodes comprised in the subset.

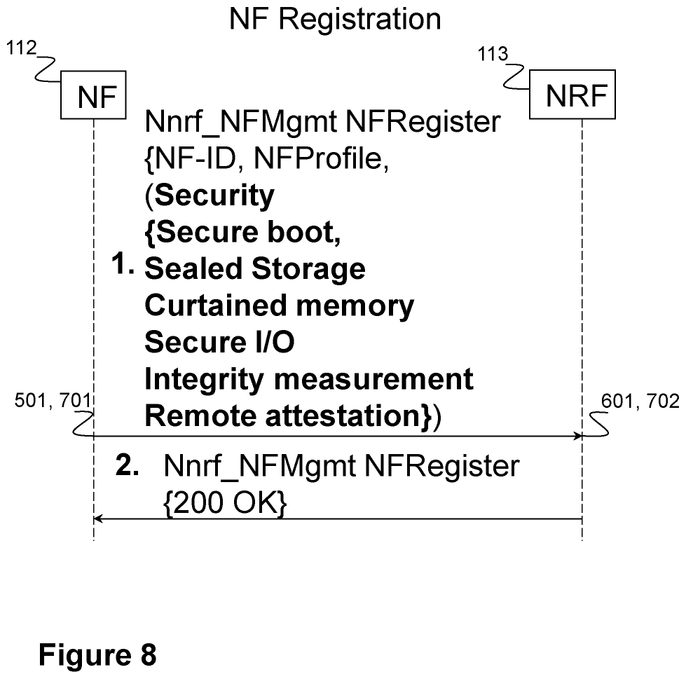

FIG. 8 is a signalling diagram depicting a non-limiting example of a method performed by the second node 112 and the third node 113, according to embodiments herein. Particularly, FIG. 8 depicts a non-limiting example of the steps for NFprofile registration, according to embodiments herein, and based on the mechanism defined in 3GPP TS 29.510, v.17.3.0. In FIG. 8, the second node 112 is an NF, and the third node 113 is an NRF. In Step 1, the second node 112, according to Actions 501 and 701, using the Nnrf_NFManagement Service API, registers its profile with the new elements described herein. Particularly, the second node 112 sends the respective first message, an Nnrf_NFMgmt NFRegister message, comprising the NF-ID and the respective first indication, as the Security IE in the NFProfile of the second node 112. The Security IE in the NFProfile indicates that the one or more respective characteristics of the respective security infrastructure of the second node 112 are: Secure boot, Sealed Storage, Curtained memory,

Secure I/O, Integrity measurement and Remote attestation. The above elements are proposed to be included in Definition of type NFProfile, that is not included in the current specification. The third node 113 receives the respective first message in accordance with Action 601 and 702. In Step 2, the NRF acknowledges this information with a Nnrf_NFMgmt NFRegister {200 OK} message.

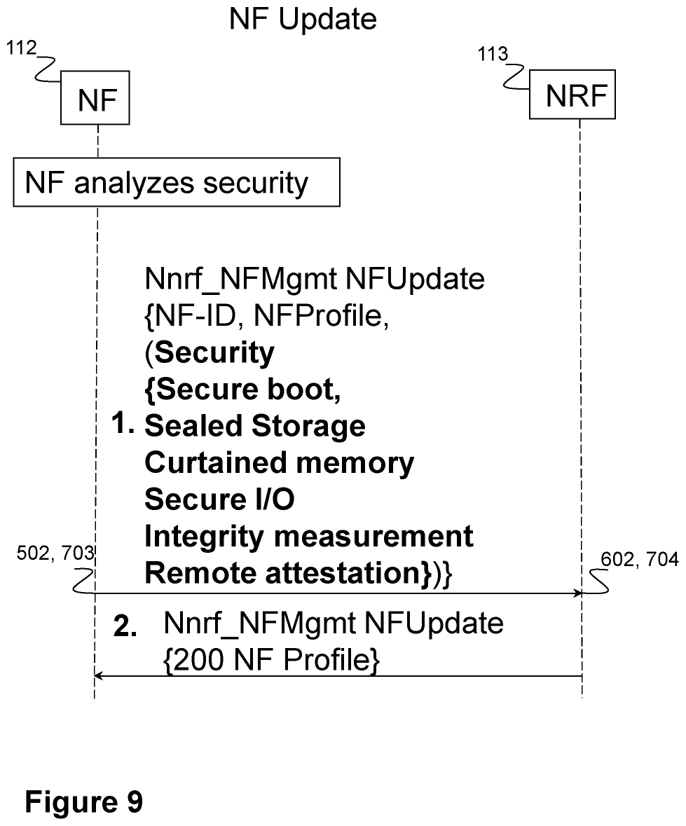

FIG. 9 is a signalling diagram depicting another non-limiting example of a method performed by the second node 112 and the third node 113, according to embodiments herein. Particularly, FIG. 9 depicts a non-limiting example of the steps for updating the NFprofile, according to embodiments herein. In FIG. 9, the second node 112 is an NF, and the third node 113 is an NRF. The second node 112 may be aware of the infrastructure where it may be deployed. The second node 112 may analyze security in the sense that if there is any change, e.g., a new board is inserted or replaced within the hardware of the second node 112, including a security related feature, the second node 112 may then update its security profile with the third node 113. In Step 1, the second node 112, according to Actions 502 and 703, using the Nnrf_NFManagement Service API, updates its profile with the new elements described herein. Particularly, the second node 112 sends the updated respective first message, an Nnrf_NFMgmt NFUpdate message, comprising the NF-ID and the updated respective first indication, as the Security IE in the NFProfile of the second node 112. The Security IE in the NFProfile indicates that the one or more respective characteristics of the respective security infrastructure of the second node 112 are: Secure boot, Sealed Storage, Curtained memory, Secure I/O, Integrity measurement and Remote attestation. The third node 113 receives the updated respective first message in accordance with Action 602 and 704. In Step 2, the NRF acknowledges this information with a Nnrf_NFMgmt NFUpdate {200 NF Profile} message.

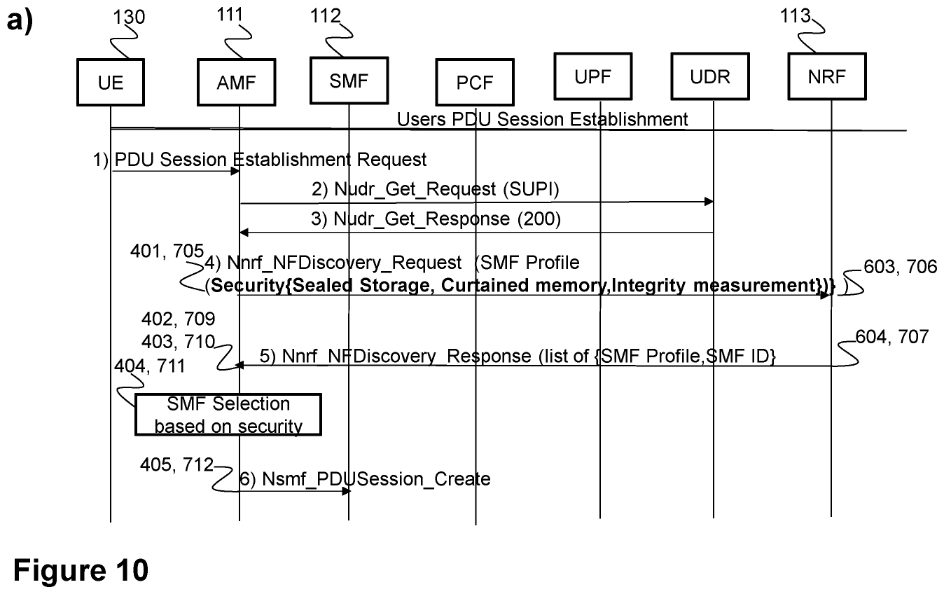

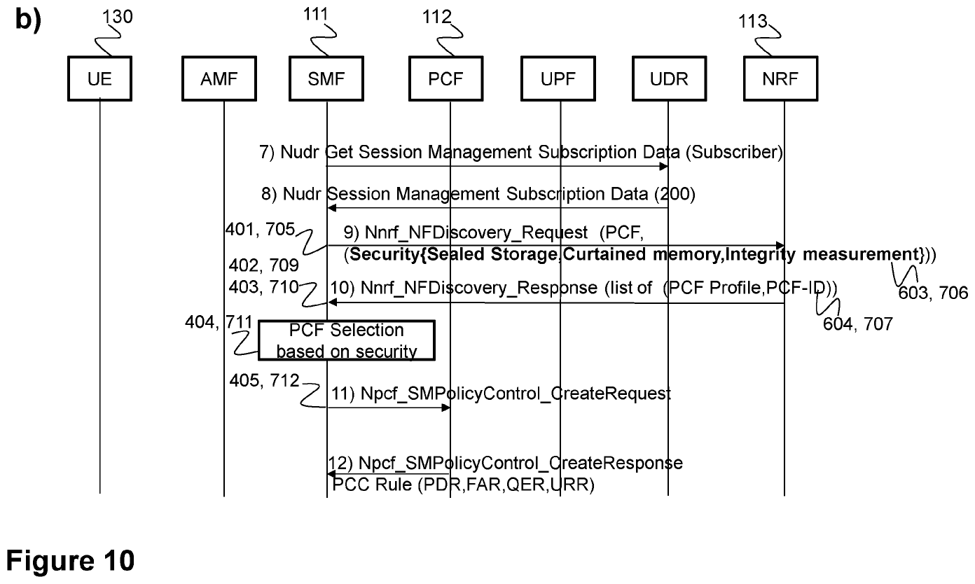

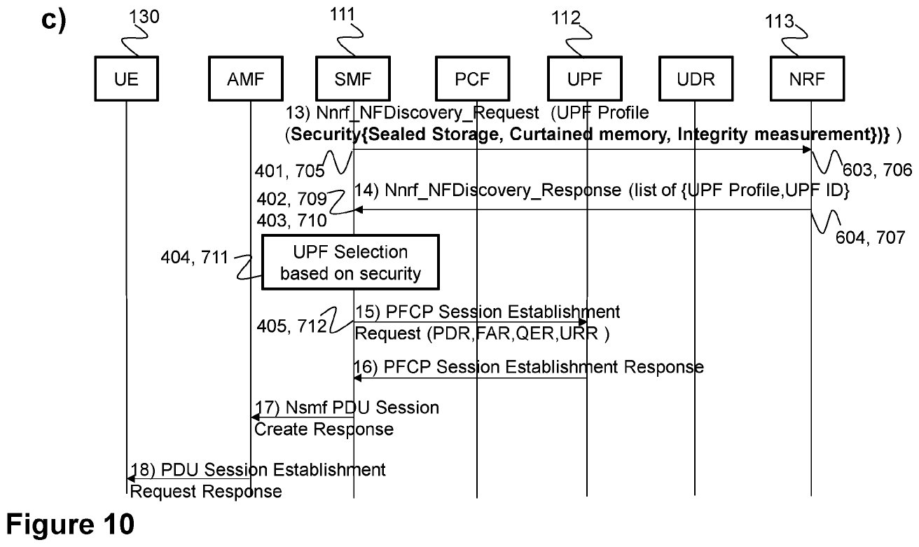

FIG. 10 is a signalling diagram depicting a non-limiting example of a method performed by the communication system 100 according to embodiments herein. In this particular non-limiting example, the first node 111, the second node 112 and the third node 113 may be different nodes in the communications system 100 at different time periods or iterations of the method, as depicted in panel a) for a first iteration, panel b) for a second iteration, and panel c) for a third iteration. The method starts with the steps in panel a) and continues with the steps in panel b), and then c). Particularly, FIG. 10 depicts a non-limiting example of the steps in the PDU session establishment procedure, according to embodiments herein. In panel a) of FIG. 10, the first node 111 is an AMF, the one or more second nodes 112 comprise the second node 112, which is an SMF, and the third node 113 is an NRF. The device 130 is a UE. In this particular non-liming example, the device 130 belongs to an enterprise that needs to have secure secrets and it provides content filtering. In Step 1, the device 130 starts a PDU Session Establishment Request. The first node 111, an AMF, receives the PDU Session Establishment Request. In Step 2, the first node 111 sends a Nudr_Get_Request_(SUPI) to the UDR in the communications system 100 to obtain subscriber information corresponding to the device 130, which it receives in a Nudr_Get_Response (200) back from the UDR in Step 3. In Step 4, the first node 111, in accordance with Action 401 and 705, asks for the one or more second nodes 112, here SMFs, using NF discovery process towards the NRF. It asks for example for those SMFs that have Sealed Storage, Curtained Memory, and Integrity measurement. The first node 111, for that purpose, sends the previous indication as a Nnrf_NFDiscovery_Request (SMF Profile (Security{Sealed Storage, Curtained memory, Integrity measurement})}. The security requirement may be understood to be that the SMFs have to be included in a trusted environment. The NRF receives the previous indication in accordance with Action 603 and 706. In Step 5, the third node 113 sends, in accordance with Action 604 and 707, the respective first indication. The third node 113 answers providing the list of SMF instances matching the requested NF Profile with the new parameter Security with the corresponding attributes defined herein. Particularly, the third node 113 sends an Nnrf_NFDiscovery_Response (list of {SMF Profile, SMF ID}. The first node 111, obtains the respective first indication in accordance with Action 402, 709. In this example, the selection of the one or more selected second nodes has been performed by the third node 113. Hence, the first node 111, in accordance with Action 403, 710, determines which are the one or more selected second nodes, by extracting their identity, SMF_ID, from the respective first indication. Next, in accordance with Action 404, 711, the first node 111 selects a subset of the selected SMFs, based on one or more additional criteria. In Step 6), in accordance with Action 405, 712, the first node 111 sends a PDU session create to the SMF instance that has been selected based on the security characteristics and the additional criteria, as an Nsmf_PDUSession_Create. In panel b) of FIG. 10, the process continues. The first node 111 is now the selected SMF, the one or more second nodes 112 comprise the second node 112, which is a PCF, and the third node 113 is the NRF. In Step 7, the first node 111, the SMF, sends a Nudr Get Session Management Subscription Data (Subscriber) to the UDR in the communications system 100 to retrieve subscription information corresponding to the device 130. In Step 8, the UDR answers with the subscription information by sending a Nudr Session Management Subscription Data (200) to the first node 111. In Step 9, the first node 111, in accordance with Action 401 and 705, asks for the one or more second nodes 112, here PCFs, using NF discovery process towards the NRF. The SMF asks for example for those PDFs that have Sealed Storage, Curtained Memory, and Integrity measurement. The first node 111, for that purpose, sends the previous indication as a Nnrf_NFDiscovery_Request (PCF (Security {Sealed Storage, Curtained memory, Integrity measurement})}. The NRF receives the previous indication in accordance with Action 603 and 706. In Step 10, the third node 113 sends, in accordance with Action 604 and 707, the respective first indication. The third node 113 answers providing the list of PCF instances matching the requested NF Profile with the new parameter Security with the corresponding attributes defined herein. Particularly, the third node 113 sends an Nnrf_NFDiscovery_Response (list of {PCF Profile, PCF-ID}. The first node 111, obtains the respective first indication in accordance with Action 402, 709. In this example, the selection of the one or more selected second nodes has been performed by the third node 113. Hence, the first node 111, in accordance with Action 403, 710, determines which are the one or more selected second nodes, by extracting their identity, PCF-ID, from the respective first indication. Next, in accordance with Action 404, 711, the first node 111 selects a subset of the selected PCFs, based on one or more additional criteria. The SMF selects the PCF instance based both on the data provided by UDR in Step 8 and the PCF instances retrieved from the NRF in Step 10 above. In Step 11, in accordance with Action 405, 712, the first node 111 SMF creates the corresponding session towards the selected PCF by sending an Npcf_SMPolicyControl_CreateRequest to the selected PCF. In Step 12, the PCF acknowledges the previous request by sending an Npcf_SMPolicyControl_CreateResponse PCC Rule (Packet Detection Rule (PDR), Forwarding Action Rule (FAR), QOS Enforcement Rule (QER), Usage Reporting Rule (URR)).

In panel c) of FIG. 10, the process continues. The first node 111 is still the selected SMF, the one or more second nodes 112 comprise the second node 112, which is a UPF, and the third node 113 is still the NRF. In Step 13, the first node 111, the SMF, in accordance with Action 401 and 705, asks for the one or more second nodes 112, here UPFs, using NF discovery process towards the NRF. In this example, the SMF, knowing that the end user needs content filtering, which it knows from the UDR subscription data, the SMF asks, for example, for those UPFs that have Sealed Storage, Curtained Memory, Integrity measurement and Remote Attestation, due to the fact that the device 130 has Content Filtering. Content filtering software may be understood to need to be installed without being changed. The first node 111, for that purpose, sends the previous indication as a Nnrf_NFDiscovery_Request (UPF Profile (Security {Sealed Storage, Curtained memory, Integrity measurement})}. The NRF receives the previous indication in accordance with Action 603 and 706. In Step 14, the third node 113 sends, in accordance with Action 604 and 707, the respective first indication. The third node 113 answers with a list of UPF instances matching the requested NF profile with the new parameter Security with the corresponding attributes defined herein. Particularly, the third node 113 sends an Nnrf_NFDiscovery_Response (list of {UPF Profile, UPF-ID}. The first node 111, obtains the respective first indication in accordance with Action 402, 709. In this example, the selection of the one or more selected second nodes has been performed by the third node 113. Hence, the first node 111, in accordance with Action 403, 710, determines which are the one or more selected second nodes, by extracting their identity, UPF-ID, from the respective first indication. Next, in accordance with Action 404, 711, the first node 111 selects a subset of the selected UPFs, based on one or more additional criteria. The SMF selects the UPF instance based both on the data provided by UDR in steps 8 and the UPF instances retrieved from NRF in step 14 above. If the UPF is for a subscriber that belongs to an Ultra Reliable Low Latency Communication (URLLC) sliced, it selects the UPF with lowest latency. In Step 15, in accordance with Action 405, 712, the first node 111 establishes a session with the selected UPF instance. SMF creates the corresponding session towards the selected PCF by sending a PFCP Session Establishment request (PDR, FAR, QER, URR) to the selected UPF. In Step 16, the UPF answers to the SMF with a PFCP Session Establishment Response. In Step 17, the SMF answers to the AMF with an Nsmf PDU Session Create Response. In Step 18, the AMF answers to the device 130 by sending a PDU Session Establishment Request Response.

It may be appreciated that FIG. 10 shows an example sequence diagram for PDU session establishment, where SMF, PCF and UPF are registered and discovered based on the new parameters disclosed herein. However, it may be understood that registration and discovery according to embodiments herein is not restricted to SMF, PCF and UPF, but may instead be understood to apply to registration and discovery of any type of NF.

Certain embodiments disclosed herein may provide one or more of the following technical advantage(s), which may be summarized as follows.

As a first advantage, embodiments herein may be understood to allow a mobile network operator to support a new procedure for (re) selecting NFs based on security characteristics of the platform.

As an additional advantage, embodiments herein may enable to provide more restrictive security permissions in terms of safe storage of the content and control of who may be accessing privacy information that may be required by those features that may be handling privacy/security information and that may be included in the mobile network.

Embodiments herein may also provide the further advantage of enabling to provide trust evidence to proof that an incident has happened in relation to the communications system 100. Content Filtering is one feature that may allow mobile network operators to block content that is not appropriate for subscribers according to business, government, parents, etc criteria. For example, companies may block some webpages during office hours to their employees or report illegal activities to authorities such browsing websites distributing illegal content. For those particular cases, companies or government may be required to have enough trust evidence to proof those incidents. Such evidence should be valid in a court. Embodiments herein facilitate the provision of such trust evidence should an incident happen.

As yet a further advantage, embodiments herein may enable to protect the reputation of parties which may install their software in shared cloud structures, which may be subject to attack.

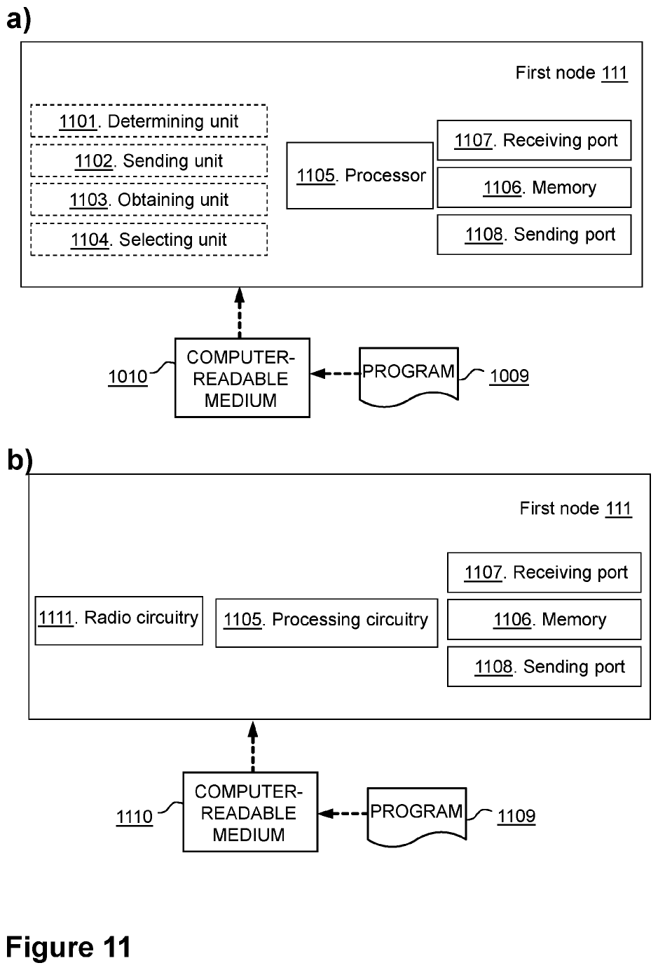

FIG. 11 depicts two different examples in panels a) and b), respectively, of the arrangement that the first node 111 may comprise to perform the method actions described above in relation to FIG. 4, FIG. 7 and/or FIG. 10. In some embodiments, the first node 111 may comprise the following arrangement depicted in FIG. 11a. The first node 111 may be understood to be for handling security. The first node 111 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 11, optional boxes are indicated by dashed lines. The detailed description of some of the following corresponds to the same references provided above, in relation to the actions described for the first node 111 and will thus not be repeated here. For example, the communications system 100 may be configured to be a 5G network, and at least one of the following may apply: a) the first node 111 may be configured to be a first network function, b) the one or more second nodes 112 may be configured to be second network functions, and c) the third node 113 may be configured to be an NRF.

The first node 111 is configured to, e.g. by means of a determining unit 1101 within the first node 111 configured to, determine, out of the one or more second nodes 112 configured to operate in the communications system 100, which one or more selected second nodes are configured to fulfil the one or more security criteria to handle data. The determining is configured to be based on the respective first indication configured to indicate the one or more respective characteristics of the respective security infrastructure of the one or more selected second nodes.

The first node 111 is also configured to, e.g. by means of a sending unit 1102 within the first node 111 configured to, send the request to establish the connection to one of the selected second nodes.

In some embodiments, the one or more respective characteristics may be configured to indicate whether or not the respective second node may be configured to be capable of at least one of: a) booting into a defined and trusted configuration, b) storing cryptographically secure information, c) providing memory isolation, d) providing secure input and output, e) computing hashes of information, and f) enabling remote attestation.

In some embodiments, each of the one or more respective characteristics may be attributes configured to be indicated in the IE configured to be comprised in the respective profile corresponding to the one or more second nodes 112.

The first node 111 may be further configured to, e.g. by means of the sending unit 1102 within the first node 111 configured to, send the previous indication to the third node 113 configured to operate in the communications system 100. The previous indication may be configured to request to indicate the one or more respective characteristics of the respective security infrastructure of the respective one or more second nodes 112.

The first node 111 may be also configured to, e.g. by means of an obtaining unit 1103 within the first node 111 configured to, obtain the respective first indication from the third node 113 based on the previous indication configured to be sent.

In some embodiments, the respective first indication may be configured to be comprised in a message. The message may be further configured to comprise a list, and one of the following may apply. In some embodiments, the list may be configured to indicate the one or more selected second nodes configured to fulfil the one or more security criteria, as configured to be selected by the third node 113. In other embodiments, the list may be configured to indicate the one or more second nodes 112, and the determining may be configured to comprise selecting the one or more selected second nodes from the list, based on the respective first indication configured to be obtained.

The first node 111 may be also configured to, e.g. by means of a selecting unit 1104 within the first node 111 configured to, select the subset of the selected second nodes, or out of the one or more second nodes 112, based on the one or more additional criteria. The request to establish the connection may be configured to be sent to at least one of one of the selected second nodes configured to be comprised in the subset.

The embodiments herein may be implemented through one or more processors, such as a processor 1105 in the first node 111 depicted in FIG. 11, together with computer program code for performing the functions and actions of the embodiments herein. The program code mentioned above may also be provided as a computer program product, for instance in the form of a data carrier carrying computer program code for performing the embodiments herein when being loaded into the in the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1106 comprising one or more memory units. The memory 1106 is arranged to be used to store obtained information, store data, configurations, schedulings, and applications etc. to perform the methods herein when being executed in the first node 111.

In some embodiments, the first node 111 may receive information from, e.g., the one or more second nodes 112, the third node 113, the device 130, and/or another node through a receiving port 1107. In some examples, the receiving port 1107 may be, for example, connected to one or more antennas in the first node 111. In other embodiments, the first node 111 may receive information from another structure in the communications system 100 through the receiving port 1107. Since the receiving port 1107 may be in communication with the processor 1105, the receiving port 1107 may then send the received information to the processor 1105. The receiving port 1107 may also be configured to receive other information.

The processor 1105 in the first node 111 may be further configured to transmit or send information to e.g., the one or more second nodes 112, the third node 113, the device 130, and/or another node, another structure in the communications system 100, through a sending port 1108, which may be in communication with the processor 1105, and the memory 1106.

Those skilled in the art will also appreciate that any of the units 1101-1104 described above may refer to a combination of analog and digital circuits, and/or one or more processors configured with software and/or firmware, e.g., stored in memory, that, when executed by the one or more processors such as the processor 1105, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1101-1104 described above may be the processor 1105 of the first node 111, or an application running on such processor.

Thus, the methods according to the embodiments described herein for the first node 111 may be respectively implemented by means of a computer program 1109 product, comprising instructions, i.e., software code portions, which, when executed on at least one processor 1105, cause the at least one processor 1105 to carry out the actions described herein, as performed by the first node 111. The computer program 1109 product may be stored on a computer-readable storage medium 1110. The computer-readable storage medium 1110, having stored thereon the computer program 1109, may comprise instructions which, when executed on at least one processor 1105, cause the at least one processor 1105 to carry out the actions described herein, as performed by the first node 111. In some embodiments, the computer-readable storage medium 1110 may be a non-transitory computer-readable storage medium, such as a CD ROM disc, a memory stick, or stored in the cloud space. In other embodiments, the computer program 1109 product may be stored on a carrier containing the computer program, wherein the carrier is one of an electronic signal, optical signal, radio signal, or the computer-readable storage medium 1110, as described above.

The first node 111 may comprise an interface unit to facilitate communications between the first node 111 and other nodes or devices, e.g., the one or more second nodes 112, the third node 113, the device 130, another node, and/or another structure in the communications system 100. In some particular examples, the interface may, for example, include a transceiver configured to transmit and receive radio signals over an air interface in accordance with a suitable standard.

In other embodiments, the first node 111 may comprise the following arrangement depicted in FIG. 11b. The first node 111 may comprise a processing circuitry 1105, e.g., one or more processors such as the processor 1105, in the first node 111 and the memory 1106. The first node 111 may also comprise a radio circuitry 1111, which may comprise e.g., the receiving port 1107 and the sending port 1108. The processing circuitry 1105 may be configured to, or operable to, perform the method actions according to FIG. 4, FIG. 7 and/or FIG. 10, in a similar manner as that described in relation to FIG. 11a. The radio circuitry 1111 may be configured to set up and maintain at least a wireless connection with the one or more second nodes 112, the third node 113, the device 130, another node, and/or another structure in the communications system 100.

Hence, embodiments herein also relate to the first node 111 operative for handling security, the first node 111 is operative to operate in the communications system 100. The first node 111 may comprise the processing circuitry 1105 and the memory 1106, said memory 1106 containing instructions executable by said processing circuitry 1105, whereby the first node 111 is further operative to perform the actions described herein in relation to the first node 111, e.g., in FIG. 4, FIG. 7 and/or FIG. 10.

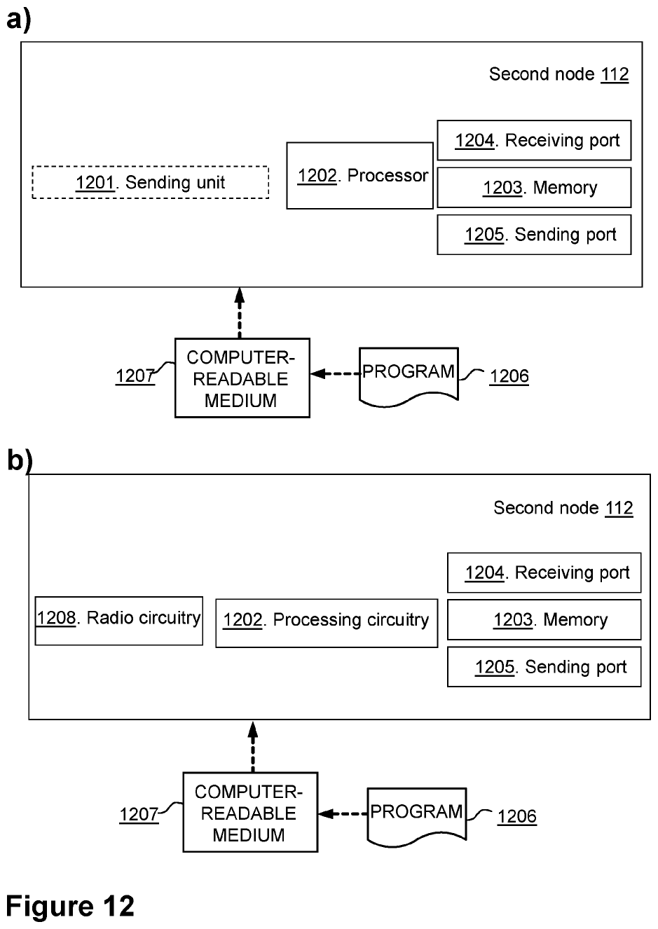

FIG. 12 depicts two different examples in panels a) and b), respectively, of the arrangement that the second node 112, may comprise to perform the method actions described above in relation to FIG. 5, FIG. 7 and/or FIGS. 8-10. In some embodiments, the second node 112 may comprise the following arrangement depicted in FIG. 12a. The second node 112 may be understood to be for handling security. The second node 112 is configured to operate in the communications system 100.

The arrangement described for the second node 112 may be understood to apply to any of the one or more second nodes 112.

Several embodiments are comprised herein. Components from one embodiment may be tacitly assumed to be present in another embodiment and it will be obvious to a person skilled in the art how those components may be used in the other exemplary embodiments. In FIG. 12, optional boxes are indicated by dashed lines. The detailed description of some of the following corresponds to the same references provided above, in relation to the actions described for the second node 112 and will thus not be repeated here. For example, the communications system 100 may be configured to be a 5G network, and at least one of the following may apply: a) the second node 112 may be configured to be a network function, and b) the third node 113 may be configured to be an NRF.

The second node 112 is configured to, e.g. by means of a sending unit 1201 within the second node 112 configured to, send the respective first message configured to indicate the respective first indication to the third node 113 configured to operate in the communications system 100. The respective first indication is configured to indicate the one or more respective characteristics of the respective security infrastructure of the second node 112.

In some embodiments, the one or more respective characteristics may be configured to indicate whether or not the second node 112 may be configured to be capable of at least one of: a) booting into a defined and trusted configuration, b) storing cryptographically secure information, c) providing memory isolation, d) providing secure input and output, e) computing hashes of information, and f) enabling remote attestation.

In some embodiments, each of the one or more respective characteristics may be attributes configured to be indicated in the IE configured to be comprised in the respective profile corresponding to the one or more second nodes 112.

The second node 112 is also configured to, e.g. by means of the sending unit 1201 within the second node 112 configured to, send the updated respective first message configured to indicate the updated respective first indication to the third node 113.

The embodiments herein may be implemented through one or more processors, such as a processor 1202 in the second node 112 depicted in FIG. 12, together with computer program code for performing the functions and actions of the embodiments herein. The program code mentioned above may also be provided as a computer program product, for instance in the form of a data carrier carrying computer program code for performing the embodiments herein when being loaded into the in the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1203 comprising one or more memory units. The memory 1203 is arranged to be used to store obtained information, store data, configurations, schedulings, and applications etc. to perform the methods herein when being executed in the second node 112.

In some embodiments, the second node 112 may receive information from, e.g., the first node 111, any of the other second nodes, the third node 113, the device 130, and/or another node, through a receiving port 1204. In some examples, the receiving port 1204 may be, for example, connected to one or more antennas in the second node 112. In other embodiments, the second node 112 may receive information from another structure in the communications system 100 through the receiving port 1204. Since the receiving port 1204 may be in communication with the processor 1202, the receiving port 1204 may then send the received information to the processor 1202. The receiving port 1204 may also be configured to receive other information.

The processor 1202 in the second node 112 may be further configured to transmit or send information to e.g., the first node 111, any of the other second nodes, the third node 113, the device 130, another node and/or another structure in the communications system 100, through a sending port 1205, which may be in communication with the processor 1202, and the memory 1203.

Those skilled in the art will also appreciate that any of the units 1201 described above may refer to a combination of analog and digital circuits, and/or one or more processors configured with software and/or firmware, e.g., stored in memory, that, when executed by the one or more processors such as the processor 1202, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1201 described above may be the processor 1202 of the second node 112, or an application running on such processor.

Thus, the methods according to the embodiments described herein for the second node 112 may be respectively implemented by means of a computer program 1206 product, comprising instructions, i.e., software code portions, which, when executed on at least one processor 1202, cause the at least one processor 1202 to carry out the actions described herein, as performed by the second node 112. The computer program 1206 product may be stored on a computer-readable storage medium 1207. The computer-readable storage medium 1207, having stored thereon the computer program 1206, may comprise instructions which, when executed on at least one processor 1202, cause the at least one processor 1202 to carry out the actions described herein, as performed by the second node 112. In some embodiments, the computer-readable storage medium 1207 may be a non-transitory computer-readable storage medium, such as a CD ROM disc, a memory stick, or stored in the cloud space. In other embodiments, the computer program 1206 product may be stored on a carrier containing the computer program, wherein the carrier is one of an electronic signal, optical signal, radio signal, or the computer-readable storage medium 1207, as described above.

The second node 112 may comprise an interface unit to facilitate communications between the second node 112 and other nodes or devices, e.g., the first node 111, any of the other second nodes, the third node 113, the device 130, another node and/or another structure in the communications system 100. In some particular examples, the interface may, for example, include a transceiver configured to transmit and receive radio signals over an air interface in accordance with a suitable standard.

In other embodiments, the second node 112 may comprise the following arrangement depicted in FIG. 12b. The second node 112 may comprise a processing circuitry 1202, e.g., one or more processors such as the processor 1202, in the second node 112 and the memory 1203. The second node 112 may also comprise a radio circuitry 1208, which may comprise e.g., the receiving port 1204 and the sending port 1205. The processing circuitry 1202 may be configured to, or operable to, perform the method actions according to FIG. 5, FIG. 7 and/or FIGS. 8-10, in a similar manner as that described in relation to FIG. 12a. The radio circuitry 1208 may be configured to set up and maintain at least a wireless connection with the first node 111, any of the other second nodes, the third node 113, the device 130, another node and/or another structure in the communications system 100.

Hence, embodiments herein also relate to the second node 112 operative for handling security, the second node 112 being operative to operate in the communications system 100. The second node 112 may comprise the processing circuitry 1202 and the memory 1203, said memory 1203 containing instructions executable by said processing circuitry 1202, whereby the second node 112 is further operative to perform the actions described herein in relation to the second node 112, e.g., in FIG. 5, FIG. 7 and/or FIGS. 8-10.

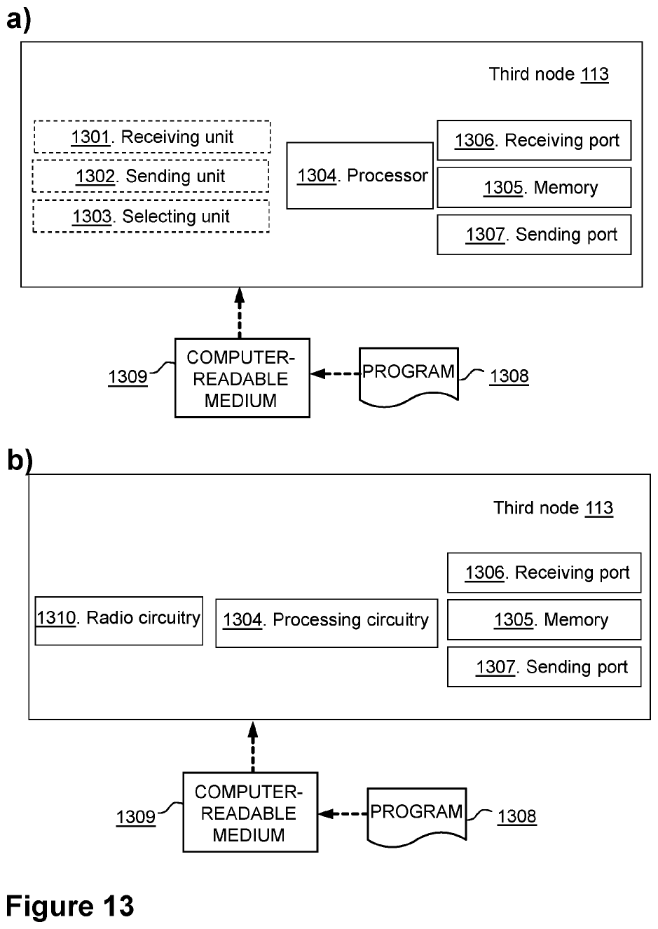

FIG. 13 depicts two different examples in panels a) and b), respectively, of the arrangement that the third node 113 may comprise to perform the method actions described above in relation to FIG. 6, FIG. 7 and/or FIGS. 8-10. In some embodiments, the third node 113 may comprise the following arrangement depicted in FIG. 13a. The third node 113 may be understood to be for handling security. The third node 113 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 13, optional boxes are indicated by dashed lines. The detailed description of some of the following corresponds to the same references provided above, in relation to the actions described for the third node 113 and will thus not be repeated here. For example, the communications system 100 may be configured to be a 5G network, and at least one of the following may apply: a) the first node 111 may be configured to be a first network function, b) the one or more second nodes 112 may be configured to be second network functions, and c) the third node 113 may be configured to be an NRF.

The third node 113 is configured to, e.g. by means of a receiving unit 1301 within the third node 113 configured to, receive the previous indication from the first node 111 configured to operate in the communications system 100. The previous indication is configured to request to indicate the one or more respective characteristics of the respective security infrastructure of the respective one or more second nodes 112 configured to operate in the communications system 100.

The third node 113 is also configured to, e.g. by means of a sending unit 1302 within the third node 113 configured to, send the respective first indication to the first node 111, based on the previous indication configured to be received. The respective first indication is configured to indicate the one or more respective characteristics of the respective security infrastructure of the one or more second nodes 112.

In some embodiments, the one or more respective characteristics may be configured to indicate whether or not the respective second node may be configured to be capable of at least one of: a) booting into a defined and trusted configuration, b) storing cryptographically secure information, c) providing memory isolation, d) providing secure input and output, e) computing hashes of information, and f) enabling remote attestation.

In some embodiments, each of the one or more respective characteristics may be attributes configured to be indicated in the IE configured to be comprised in the respective profile corresponding to the one or more second nodes 112.

In some embodiments, the respective first indication may be configured to be comprised in a message. The message may be further configured to comprise the list comprising the one or more second nodes 112.

In some embodiments wherein the respective first indication may be configured to be comprised in a message, the third node 113 may be also configured to, e.g. by means of a selecting unit 1303 within the third node 113 configured to, select the one or more selected second nodes configured to fulfil the one or more security criteria configured to be indicated in the previous indication. The one or more selected second nodes may be configured to be comprised in the list comprised in the message.

The third node 113 may be configured to, e.g. by means of the receiving unit 1301 within the third node 113 configured to, receive the respective first message configured to indicate the respective first indication from the respective one or more second nodes 112. The respective first indication may be configured to indicate the one or more respective characteristics of the respective security infrastructure of the respective one or more second nodes 112.

The third node 113 may be configured to, e.g. by means of the receiving unit 1301 within the third node 113 configured to, receive the updated respective first message configured to indicate the updated respective first indication from at least one of the respective one or more second nodes 112. The respective first indication configured to be sent may be configured to be based on the updated respective first indication configured to be received.

The embodiments herein may be implemented through one or more processors, such as a processor 1304 in the third node 113 depicted in FIG. 13, together with computer program code for performing the functions and actions of the embodiments herein. The program code mentioned above may also be provided as a computer program product, for instance in the form of a data carrier carrying computer program code for performing the embodiments herein when being loaded into the in the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1305 comprising one or more memory units. The memory 1305 is arranged to be used to store obtained information, store data, configurations, schedulings, and applications etc. to perform the methods herein when being executed in the third node 113.

In some embodiments, the third node 113 may receive information from, e.g., the first node 111, the one or more second nodes 112, the device 130, and/or another node, through a receiving port 1306. In some examples, the receiving port 1306 may be, for example, connected to one or more antennas in the third node 113. In other embodiments, the third node 113 may receive information from another structure in the communications system 100 through the receiving port 1306. Since the receiving port 1306 may be in communication with the processor 1304, the receiving port 1306 may then send the received information to the processor 1304. The receiving port 1306 may also be configured to receive other information.

The processor 1304 in the third node 113 may be further configured to transmit or send information to e.g., the first node 111, the one or more second nodes 112, the device 130, another node, and/or another structure in the communications system 100, through a sending port 1307, which may be in communication with the processor 1304, and the memory 1305.

Those skilled in the art will also appreciate that the units 1301-1303 described above may refer to a combination of analog and digital circuits, and/or one or more processors configured with software and/or firmware, e.g., stored in memory, that, when executed by the one or more processors such as the processor 1304, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The units 1301-1303 described above may be the processor 1304 of the third node 113, or an application running on such processor.

Thus, the methods according to the embodiments described herein for the third node 113 may be respectively implemented by means of a computer program 1308 product, comprising instructions, i.e., software code portions, which, when executed on at least one processor 1304, cause the at least one processor 1304 to carry out the actions described herein, as performed by the third node 113. The computer program 1308 product may be stored on a computer-readable storage medium 1309. The computer-readable storage medium 1309, having stored thereon the computer program 1308, may comprise instructions which, when executed on at least one processor 1304, cause the at least one processor 1304 to carry out the actions described herein, as performed by the third node 113. In some embodiments, the computer-readable storage medium 1309 may be a non-transitory computer-readable storage medium, such as a CD ROM disc, a memory stick, or stored in the cloud space. In other embodiments, the computer program 1308 product may be stored on a carrier containing the computer program, wherein the carrier is one of an electronic signal, optical signal, radio signal, or the computer-readable storage medium 1309, as described above.

The third node 113 may comprise an interface unit to facilitate communications between the third node 113 and other nodes or devices, e.g., the first node 111, the one or more second nodes 112, the device 130, another node, and/or another structure in the communications system 100. In some particular examples, the interface may, for example, include a transceiver configured to transmit and receive radio signals over an air interface in accordance with a suitable standard.

In other embodiments, the third node 113 may comprise the following arrangement depicted in FIG. 13b. The third node 113 may comprise a processing circuitry 1304, e.g., one or more processors such as the processor 1304, in the third node 113 and the memory 1305. The third node 113 may also comprise a radio circuitry 1310, which may comprise e.g., the receiving port 1306 and the sending port 1307. The processing circuitry 1304 may be configured to, or operable to, perform the method actions according to FIG. 6, FIG. 7 and/or FIGS. 8-10, in a similar manner as that described in relation to FIG. 13a. The radio circuitry 1310 may be configured to set up and maintain at least a wireless connection with the first node 111, the one or more second nodes 112, the device 130, another node, and/or another structure in the communications system 100.

Hence, embodiments herein also relate to the third node 113 operative for handling security, the third node 113 being operative to operate in the communications system 100. The third node 113 may comprise the processing circuitry 1304 and the memory 1305, said memory 1305 containing instructions executable by said processing circuitry 1304, whereby the third node 113 is further operative to perform the actions described herein in relation to the third node 113, e.g., in FIG. 6, FIG. 7 and/or FIGS. 8-10.

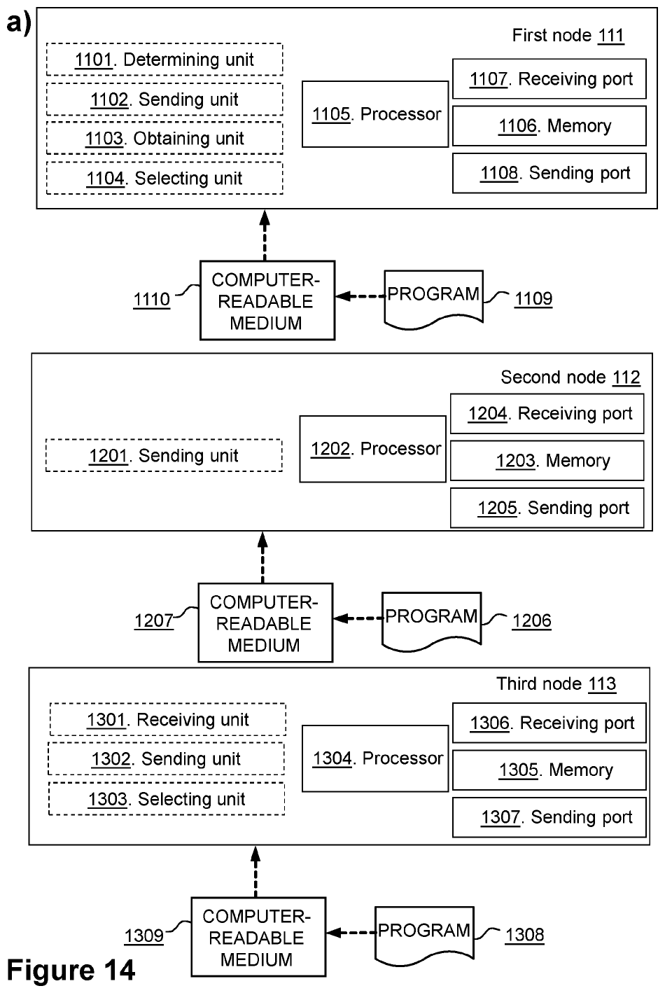

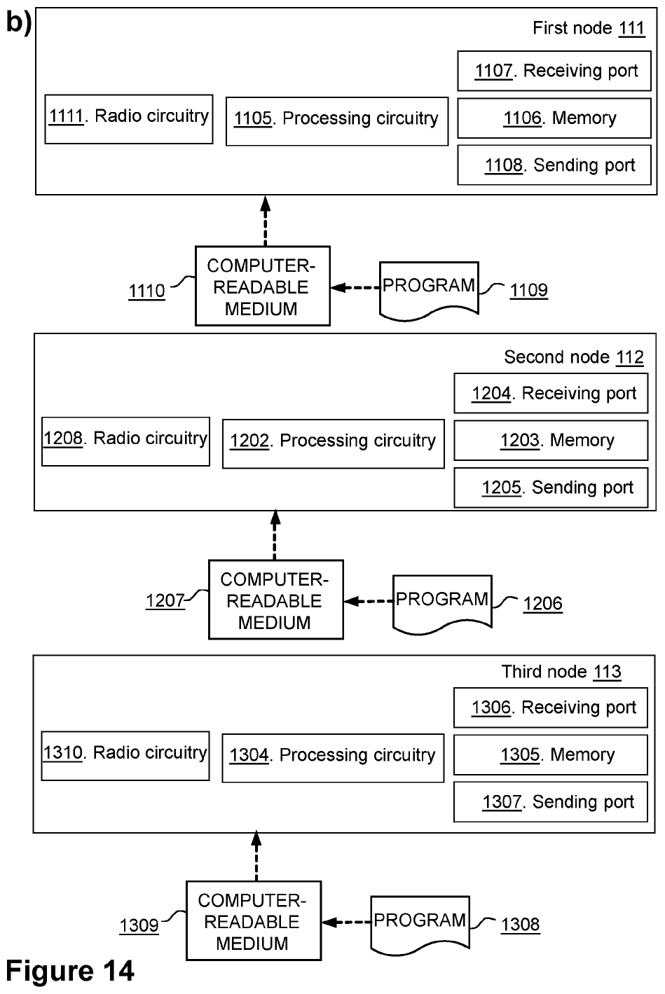

FIG. 14 depicts two different examples in panels a) and b), respectively, of the arrangement that the communications system 100 may comprise to perform the method actions described above in relation to FIG. 7 and/or FIG. 10. The arrangement depicted in panel a) corresponds to that described in relation to panel a) in FIG. 11, FIG. 12 and FIG. 13 for each of the first node 111, the second node 112 and the third node 113, respectively. The arrangement depicted in panel b) corresponds to that described in relation to panel b) in FIG. 11, FIG. 12 and FIG. 13 for each of the first node 111, the second node 112 and the third node 113, respectively. The communications system 100 may be for handling security. The communications system 100 is configured to comprise the first node 111, the one or more second nodes 112 and the third node 113.

The communications system 100 is configured to, e.g. by means of the sending unit 1201 within the second node 112 configured to, send, by the one or more second nodes 112, the respective first message configured to indicate the respective first indication to the third node 113. The respective first indication is configured to indicate the one or more respective characteristics of the respective security infrastructure of the one or more second nodes 112.

The communications system 100 is also configured to, e.g. by means of the receiving unit 1301 within the one or more second nodes 112 configured to, receive, by the third node 113, the respective first messages configured to indicate the respective first indication from the respective one or more second nodes 112. The respective first indication is configured to indicate the one or more respective characteristics of the respective security infrastructure of the respective one or more second nodes 112.

The communications system 100 is configured to, e.g. by means of the sending unit 1102 within the first node 111 configured to, send, by the first node 111, the previous indication to the third node 113. The previous indication is configured to request to indicate the one or more respective characteristics of the respective security infrastructure of the respective one or more second nodes 112.

The communications system 100 is also configured to, e.g. by means of the receiving unit 1301 within the third node 113 configured to, receive, by the third node 113, the previous indication from the first node 111.

The communications system 100 is configured to, e.g. by means of the sending unit 1302 within the third node 113 configured to, send, by the third node 113, based on the previous indication configured to be received. The respective first indication is configured to indicate the one or more respective characteristics of the respective security infrastructure of the one or more second nodes 112.

The communications system 100 is also configured to, e.g. by means of the obtaining unit 1103 within the first node 111 configured to, obtain, by the first node 111, the respective first indication from the third node 113 based on the previous indication configured to be sent.

The communications system 100 is further configured to, e.g. by means of the determining unit 1101 within the first node 111 configured to, determine, by the first node 111, out of the one or more second nodes 112, which one or more selected second nodes are configured to fulfil one or more security criteria to handle data. The determining is configured to be based on the respective first indication.

The communications system 100 may be further configured to, e.g. by means of the sending unit 1102 within the first node 111 further configured to send, by the first node 111, the request to establish the connection to the one of the selected second nodes.

In some embodiments, the one or more respective characteristics may be configured to indicate whether or not the respective second node may be configured to be capable of at least one of: a) booting into the defined and trusted configuration, b) storing cryptographically secure information, c) providing memory isolation, d) providing secure input and output, e) computing hashes of information, and f) enabling remote attestation.

In some embodiments, each of the one or more respective characteristics may be attributes configured to be indicated in the IE configured to be comprised in the respective profile corresponding to the one or more second nodes 112.

In some embodiments, the respective first indication may be configured to be comprised in a message. The message may be further configured to comprise a list, and one of the following may apply. In some embodiments, the list may be configured to indicate the one or more selected second nodes configured to fulfil the one or more security criteria, as configured to be selected by the third node 113. In other embodiments, the list may be configured to indicate the one or more second nodes 112, and the determining may be configured to comprise selecting the one or more selected second nodes from the list, based on the respective first indication configured to be obtained.

The communications system 100 may be further configured to, e.g., by means of the selecting unit 1104 within the first node 111 configured to, select, by the first node 111, the subset of the selected second nodes, or out of the one or more second nodes 112, based on the one or more additional criteria. The request to establish the connection may be configured to be sent to at least one of one of the selected second nodes configured to be comprised in the subset.

In some embodiments wherein the respective first indication may be configured to be comprised in a message, the third node 113 may be also configured to, e.g. by means of a selecting unit 1303 within the third node 113 configured to, select, by the third node 113, the one or more selected second nodes configured to be fulfilling the one or more security criteria configured to be indicated in the previous indication. The one or more selected second nodes may be configured to be comprised in the list comprised in the message.

The second node 112 may be also configured to, e.g. by means of the sending unit 1201 within the second node 112 configured to, send, by at least one second node 112, the updated respective first message configured to indicate the updated respective first indication to the third node 113.

The third node 113 may be configured to, e.g. by means of the receiving unit 1301 within the third node 113 configured to, receive, by the third node 113, the updated respective first message configured to indicate the updated respective first indication from at least one of the respective one or more second nodes 112. The respective first indication configured to be sent may be configured to be based on the updated respective first indication configured to be received.

For example, the communications system 100 may be configured to be a 5G network, and at least one of the following may apply: a) the first node 111 may be configured to be a first network function, b) the one or more second nodes 112 may be configured to be second network functions, and c) the third node 113 may be configured to be an NRF.

The remaining configurations described for the first node 111, the one or more second nodes 112 and the third node 113 in relation to FIG. 14, may be understood to correspond to those described in FIG. 11, FIG. 12 and FIG. 13, respectively, and to be performed, e.g., by means of the corresponding units and arrangements described in FIG. 11, FIG. 12 and FIG. 13, which will not be repeated here.

When using the word “comprise” or “comprising”, it shall be interpreted as non-limiting, i.e. meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of: ” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of: ” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

1-56. (canceled)

57. A computer-implemented method, performed by a first node, for handling security, the first node operating in a communications system, the method comprising:
determining, out of one or more second nodes operating in the communications system, which one or more selected second nodes fulfil one or more security criteria to handle data, the determining being based on a respective first indication indicating one or more respective characteristics of a respective security infrastructure of the one or more selected second nodes; and
sending a request to establish a connection to one of the selected second nodes.

58. The computer-implemented method according to claim 57, wherein the one or more respective characteristics indicate whether or not a respective second node is capable of at least one of:
booting into a defined and trusted configuration;
storing cryptographically secure information;
providing memory isolation;
providing secure input and output;
computing hashes of information; and
enabling remote attestation.

59. The computer-implemented method according to claim 57, wherein each of the one or more respective characteristics are attributes indicated in an information element (IE) comprised in a respective profile corresponding to the one or more second nodes.

60. The computer-implemented method according to claim 57 wherein the method further comprises:
sending a previous indication to a third node operating in the communications system, the previous indication requesting to indicate the one or more respective characteristics of the respective security infrastructure of the respective one or more second nodes; and
obtaining the respective first indication from the third node based on the sent previous indication.

61. The computer-implemented method according to claim 60, wherein the respective first indication is comprised in a message, the message further comprises a list, and wherein one of:
the list indicates the one or more selected second nodes fulfilling the one or more security criteria, as selected by the third node; and
the list indicates the one or more second nodes, and the determining comprises selecting the one or more selected second nodes from the list, based on the obtained respective first indication.

62. The computer-implemented method according to claim 60, and wherein the method further comprises:
selecting a subset of the selected second nodes, or out of the one or more second nodes, based on one or more additional criteria, and wherein the request to establish the connection is sent to at least one of one of the selected second nodes comprised in the subset.

63. The computer-implemented method according to claim 57, wherein the communications system is a Fifth Generation, 5G, network, and wherein at least one of:
the first node is a first network function;
the one or more second nodes are second network functions; and
the third node is a network repository function.

64. A computer-implemented method, performed by a third node, for handling security, the third node operating in a communications system, the method comprising:
receiving a previous indication from a first node operating in the communications system, the previous indication requesting to indicate one or more respective characteristics of a respective security infrastructure of respective one or more second nodes operating in the communications system; and
sending a respective first indication to the first node, based on the received previous indication, the respective first indication indicating one or more respective characteristics of a respective security infrastructure of the one or more second nodes.

65. The computer-implemented method according to claim 64, wherein the one or more respective characteristics indicate whether or not a respective second node is capable of at least one of:
booting into a defined and trusted configuration;
storing cryptographically secure information;
providing memory isolation;
providing secure input and output;
computing hashes of information; and
enabling remote attestation.

66. The computer-implemented method according to claim 64, wherein each of the one or more respective characteristics are attributes indicated in an information element (IE) comprised in a respective profile corresponding to the one or more second nodes.

67. The computer-implemented method according to claim 64, wherein the respective first indication is comprised in a message, the message further comprising a list comprising the one or more second nodes.

68. The computer-implemented method according to claim 64, wherein the respective first indication is comprised in a message, wherein the method further comprises:
selecting one or more selected second nodes fulfilling one or more security criteria indicated in the previous indication, and wherein the one or more selected second nodes are comprised in a list comprised in the message.

69. The computer-implemented method according to claim 64, wherein the method further comprises:
receiving a respective first message indicating a respective first indication from the respective one or more second nodes, the respective first indication indicating one or more respective characteristics of a respective security infrastructure of the respective one or more second nodes.

70. The computer-implemented method according to claim 69, wherein the method further comprises:
receiving an updated respective first message indicating an updated respective first indication from at least one of the respective one or more second nodes, and wherein the sent respective first indication is based on the received updated respective first indication.

71. The computer-implemented method according to claim 64, wherein the communications system is a Fifth Generation, 5G, network, and wherein at least one of:
the first node is a first network function;
the one or more second nodes are second network functions; and
the third node is a network repository function.

72. A first node, for handling security, the first node being configured to operate in a communications system, the first node being further configured to:
determine, out of one or more second nodes configured to operate in the communications system, which one or more selected second nodes are configured to fulfil one or more security criteria to handle data, the determining being configured to be based on a respective first indication configured to indicate one or more respective characteristics of a respective security infrastructure of the one or more selected second nodes; and
send a request to establish a connection to one of the selected second nodes.

73. The first node according to claim 72, wherein the one or more respective characteristics are configured to indicate whether or not a respective second node is configured to be capable of at least one of:
booting into a defined and trusted configuration;
storing cryptographically secure information;
providing memory isolation;
providing secure input and output;
computing hashes of information; and
enabling remote attestation.

74. A third node, for handling security, the third node being configured to operate in a communications system, the third node being further configured to:
receive a previous indication from a first node configured to operate in the communications system, the previous indication being configured to request to indicate one or more respective characteristics of a respective security infrastructure of respective one or more second nodes configured to operate in the communications system; and
send a respective first indication to the first node, based on the previous indication configured to be received, the respective first indication being configured to indicate one or more respective characteristics of a respective security infrastructure of the one or more second nodes.

75. The third node according to claim 74, wherein the one or more respective characteristics are configured to indicate whether or not a respective second node is configured to be capable of at least one of:
booting into a defined and trusted configuration;
storing cryptographically secure information;
providing memory isolation;
providing secure input and output;
computing hashes of information; and
enabling remote attestation.
